(19) United States
(12) Patent Application Publication
(10) Pub. No.: US 2014/0036114 A1
(43) Pub. Date: Feb. 6, 2014

(54) SOLID-STATE IMAGING DEVICE AND IMAGING APPARATUS

(71) Applicant: PANASONIC CORPORATION, Osaka (JP)

(72) Inventors: Koujirou YONEDA, Kyoto (JP); Kenji WATANABE, Kyoto (JP); Takeshi SOWA, Kyoto (JP)

(73) Assignee: PANASONIC CORPORATION, Osaka (JP)

(21) Appl. No.: 14/052,518

(22) Filed: Oct. 11, 2013

Related U.S. Application Data
(63) Continuation of application No. PCT/JP2012/002655, filed on Apr. 17, 2012.

(30) Foreign Application Priority Data
Apr. 22, 2011 (JP) 2011-096462

(51) Int. Cl. H04N 5/367; H04N 5/378

(52) U.S. Cl. CPC H04N 5/367; H04N 5/378
USPC 348/247; 250/208.1

(57) ABSTRACT

A solid-state imaging device includes: an imaging unit; a row selection circuit; a column circuit unit; and a control unit configured to supply a row address signal which designates a pixel row to be selected to the row selection circuit, in which the imaging unit includes: a valid part including first pixels; and a peripheral part including second pixels, and the control unit includes an output adjustment unit which adjusts an output order of row address signals, the output adjustment unit adjusts the output order of the row address signals so that orders and combinations of the numbers of rows to be outputted per unit row are equal to each other in a first row selection sequence and in a second row selection sequence, and generate the first and second row selection sequences, and the control unit supplies the first and second row selection sequences to the row selection circuit.

### CROSS REFERENCE TO RELATED APPLICATIONS

This is a continuation application of PCT International Application No. PCT/JP2012/002655 filed on Apr. 17, 2012, designating the United States of America, which is based on and claims priority of Japanese Patent Application No. 2011-096462 filed on Apr. 22, 2011. The entire disclosures of the above-identified applications, including the specifications, drawings and claims are incorporated herein by reference in their entirety.

### FIELD

One or more exemplary embodiments disclosed herein relate generally to solid-state imaging devices having pixels which are arranged two-dimensionally on a semiconductor substrate and perform photoelectric conversion on incident light, and imaging apparatuses. In particular, according to the present invention, a solid-state imaging device capable of obtaining a high quality image in which pixel signals from pixels are mixed and an imaging apparatus can be achieved.

### BACKGROUND

Metal oxide semiconductor (MOS) imaging sensors have excellent properties, such as high speed and high sensitivity. In recent years, a market of digital single-lens reflex (DSLR) cameras equipped with the MOS imaging sensors has expanded rapidly. Furthermore, in recent years, DSLR cameras which are equipped with a function of recording high-definition moving pictures in addition to a function of taking a still pictures have increased. This means that the MOS imaging sensors are required to exhibit pictures with high quality not only in an all-pixel readout mode for taking still pictures but also in a pixel-mixture mode for taking moving pictures.

FIG. 23 shows an entire configuration of a conventional solid-state imaging device disclosed in Patent Literature (PTL) 1. The solid-state imaging device shown in FIG. 23 includes an imaging device 200, a pixel 202, and a pixel readout circuit 250.

As shown in FIG. 23, the pixel 202 includes a photodiode 211, a reset transistor 214, an amplification transistor 215, and a selection transistor 216. The pixel readout circuit 250 includes a current source 253, a grounding transistor 254, a load transistor 255, and a sourcing transistor 256. Furthermore, there are provided a first column wiring 221 and a second column wiring 222 as output wirings for pixel signals, and a first pixel output 257 and a second pixel output 258 as output terminals.

An operation of the conventional solid-state imaging device is described. Driving modes are sorted into two types, such as the all-pixel readout mode and the pixel-mixture mode.

In the all-pixel readout mode, the grounding transistor 254 is set to be OFF while the sourcing transistor 256 is set to be ON. The current source 253 is connected to a source terminal or a drain terminal, which is placed on a side closer to the selection transistor, of the amplification transistor 215 in a pixel via the first column wiring 221, while a power source is connected to a source terminal or a drain terminal, which is placed on a side opposite to the side closer to the selection transistor, via the second column wiring 222. With this configuration, the amplification transistor 215 and the current source 253 in the pixel 202 function as a source follower amplifier so as to read a pixel signal from the first pixel output 257. The selection transistors 216 are sequentially set to be ON for one-by-one row to read pixel signals, resulting in reading signals of all of the pixels 202.

On the other hand, in the pixel-mixture mode, the grounding transistor 254 is set to be ON, while the sourcing transistor 256 is set to be OFF. A source terminal or a drain terminal, which is placed on a side closer to the selection transistor 216, of the amplification transistor 215 in the pixel 202 is grounded via the first column wiring 221, while a source terminal or a drain terminal, which is placed on a side opposite to the side closer to the selection transistor 216, is connected to the load transistor 255 via the second column wiring 222. With this configuration, the amplification transistor 215 and the load transistor 255 in the pixel 202 function as a source grounding amplifier. When two selection transistors 216 in two rows are set to be ON at the same time, a mixed signal from two pixels which are an upper pixel and a lower pixel can be obtained from the second pixel output 258. The selection transistors 216 are sequentially set to be ON for two rows at a time and pixel signals are read, resulting in reading mixed signals in an entire of the imaging unit 200.

The imaging unit 200 includes, in a camera, a valid part to be used for image information and a peripheral part provided with light-shielding pixels around the valid part. Operations in the respective driving modes are identical between the valid part and the peripheral part.

### CITATION LIST

### Patent Literature

[PTL 1] Specification of the U.S. Pat. No. 7,091,466

### SUMMARY

### Technical Problem

Typically, in a large sensor such as a sensor for a DSLR camera, variation occurs in offset voltages in readout circuits in respective columns. This means that an offset component fluctuates in a horizontal direction in an output signal which is in a dark state and serves as a standard level. This causes a horizontal shading in an image, which leads to deterioration in image quality.

Countermeasures for the horizontal shading include a method in which correction data is generated using an output signal from a light-shielding pixel provided in the peripheral part in an imaging unit, and correction is performed by a digital signal processor in a later step.

However, in a conventional solid-state imaging device, the number of pixel rows from which pixel signals for generating the correction data are outputted is significantly small in a pixel-mixture mode in comparison with an all-pixel readout mode. Since a pixel readout signal includes fluctuation in a power supply and a random noise due to noise or the like unique to a device, decrease in the small number of rows for the correction leads to deterioration in accuracy of the correction data, which decreases image quality.

In addition, measures for making up for the small number of rows for the correction include a measure for increasing the number of rows physically. However, this means leads to increase in a parasitic capacitance of a circuit, which is undesirable in terms of power consumption.

In view of the above, one non-limiting and exemplary embodiment provides a solid-state imaging device in which the decrease in the accuracy of the correction data in the pixel-mixture mode is suppressed.

### Solution to Problem

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

In one general aspect, the techniques disclosed here feature a solid-state imaging device including: an imaging unit including a plurality of pixels arranged two-dimensionally; a row selection circuit which selects a pixel row including pixels among the pixels arranged in a row direction; a column circuit unit configured to temporarily hold pixel signals outputted from the selected pixel row; and a control unit configured to supply a row address signal which designates a pixel row to be selected to the row selection circuit, in which the pixels include: a plurality of first pixels which output pixel signals dependent on quantity of received light; and a plurality of second pixels which output pixel signals at a constant intensity regardless of the quantity of the received light, the imaging unit includes: a valid part including the first pixels; and a peripheral part including the second pixels which are arranged on a periphery of the valid part, and the control unit is configured to generate and supply, to the row selection circuit, a first row selection sequence including the row address signal which designates the pixel row belonging to the valid part and a second row selection sequence including the row address signal which designates the pixel row belonging to the peripheral part so that the number of pixel rows simultaneously designated in the first row selection sequence and the second row selection sequence or the number of times that each of the pixel rows is designated varies, in at least one of the driving modes.

With this configuration, when pixel signals in the valid part and pixel signals in the peripheral part are outputted, the rows are selected using the respective sequences. Accordingly, pixel signals in the valid part which are used for forming an image and pixel signals in the peripheral part which are used for generating correction data are outputted using the sequences appropriate for the respective pixel signals. Even if the driving mode in the solid-state imaging device is a pixel-mixture mode in which pixel signals in the valid part are mixed and outputted, pixel signals in the peripheral part are mixed in conformity with the mixture of the pixel signals in the valid part and outputted without being reduced. Therefore, deterioration in accuracy of correction data can be suppressed.

The control unit may be configured to generate the first row selection sequence and the second row selection sequence so that the number of pixel rows designated in a single row-readout period in the first row selection sequence is larger than the number of pixel rows designated in the single row-readout period in the second row selection sequence.

The control unit may be configured to generate, in a single frame period, the first row selection sequence and the second row selection sequence so that the number of times that each of the pixel rows is designated by the first row selection sequence is less than the number of times that each of the pixel rows is designated by the second row selection sequence.

With this configuration, in the peripheral part, the number of pixel rows to be mixed is small, while the number of times that each of the pixel rows is designated is large. Therefore, even if the driving mode in the solid-state imaging device is the pixel-mixture mode in which the pixel signals in the valid part are mixed and outputted, deterioration in accuracy of the correction data can be suppressed.

The control unit may be configured to designate (i) two or more of the pixel rows in a single row-readout period in the first row selection sequence, and (ii) one of the pixel rows in the single row-readout period in the second row selection sequence.

With this configuration, pixel signals in two or more rows are mixed and outputted in the readout of the pixel signals in the valid part, while pixel signals are outputted for one-by-one row in the readout of the pixel signals in the peripheral part. Accordingly, the pixel signals in the peripheral part which are used for generating the correction data can be outputted without being mixed. Consequently, deterioration in accuracy of the correction data can be suppressed without reducing the number of correction data in the pixel mixture mode.

The control unit may be configured to designate (i) two or more of the pixel rows in a single row-readout period in the first row selection sequence, and (ii) two or more of the pixel rows the number of which is different from the number of the pixel rows designated in the first row selection sequence, in the single row-readout period in the second row selection sequence.

The control unit may be configured to: (i) designate, in the first row selection sequence, two or more of the pixel rows in a single row-readout period, and (ii) designate, in the second row selection sequence, an Nth pixel row (N is an integer of 1 or more) along with an Mth pixel row (M is an integer of 1 or more, and M≠N) in the single row-readout period, and designate the Nth pixel row more than once with a value of M being changed in the single frame period.

With this configuration, pixel signals in the Nth pixel row and the Mth pixel row are mixed and outputted in the readout of the pixel signals in the valid part and the peripheral part. Accordingly, the number of times that the pixel signals are read can be reduced, so that the pixel signals can be efficiently obtained. In addition, pixel signals in the Nth pixel row and the Mth pixel row are mixed multiple times with different combination and outputted in the readout of the pixel signals in the peripheral part. Therefore, deterioration in the accuracy of the correction data can be suppressed without reducing the number of pixel signals in the peripheral part which are used for generating the correction data.

The designating more than once may indicate designating twice.

With this configuration, pixel signals in the Nth pixel row and the Mth pixel row are mixed and each of pixels is designated twice in the readout of the pixel signals in the peripheral part. Accordingly, pixel signals in the number equal to the number in the case when the pixel signals are readout one-by-one row in the peripheral part can be obtained. Therefore, regardless of difference in the driving modes, there is no concern for offset to be generated in an output even in the pixel-mixture mode, in comparison with the mode without performing the pixel mixture, to thereby generate the correction data with high accuracy. The size of a parasitic capacity of a circuit is equal to that in the mode without performing the pixel mixture. Therefore, deterioration in the accuracy of the correction data in the pixel-mixture mode can be suppressed without increasing power consumption.

In one general aspect, the techniques disclosed here feature a solid-state imaging device including: an imaging unit including a plurality of pixels arranged two-dimensionally; a row selection circuit which selects a pixel row including pixels among the pixels arranged in a row direction; a column circuit unit configured to temporarily hold pixel signals outputted from the selected pixel row; and a control unit configured to supply a row address signal which designates a pixel row to be selected to the row selection circuit, wherein the pixels include: a plurality of first pixels which output pixel signals dependent on quantity of received light; and a plurality of second pixels which output pixel signals at a constant intensity regardless of the quantity of the received light, the imaging unit includes: a valid part including the first pixels; and a peripheral part including the second pixels which are arranged on a periphery of the valid part, in at least one of the driving modes, the control unit includes an output order adjustment unit configured to adjust an output order of row address signals including the row address signal, the output order adjustment unit is configured to adjust the output order of the row address signals so that orders and combinations of the numbers of rows to be outputted per unit row are equal to each other in a first row selection sequence and in a second row selection sequence, and generate the first row selection sequence including the row address signal which designates the pixel row belonging to the valid part and the second selection sequence including the row address signal which designates the pixel row belonging to the peripheral part, and the control unit is configured to supply, to the row selection circuit, the first row selection sequence and the second row selection sequence which have been adjusted in terms of the output order of the row address signals.

With this configuration, even in a thinning mixture mode in which a ratio of thinning is high, the row selection sequence outputted from the control unit via the output adjustment unit is applied to the peripheral part, to thereby secure more output rows per unit row in the peripheral part than those in the valid part, and to make combination and an output order of the unit row numbers be equal to those in the valid part. Therefore, correction data for horizontal shading and correction data for clamping operation using the data in the peripheral part can be sufficiently obtained. This means that each correction data can be generated with high accuracy, so that the pixel mixture mode, thinning mode, and thinning mixture mode which have high image quality can be achieved.

The output order adjustment unit may be configured to generate the first row selection sequence and the second row selection sequence so that a ratio of (i) to (ii) in the first row selection sequence is smaller than a ratio of the (i) to the (ii) in the second row selection sequence, the (i) indicating the pixel row designated in a row-readout period per unit row, and the (ii) indicating the number of pixel rows per unit row.

With this configuration, outputted rows per unit row are more in the peripheral part than those in the valid part. Accordingly, the clamping correction operation data can be sufficiently obtained. This means that each of the correction data items can be generated with high accuracy, so that the pixel mixture mode, thinning mode, and thinning mixture mode which have high image quality can be achieved.

The unit row may include four pixel rows.

The unit row may include two pixel rows.

Each of the second pixels may include a light-shielding pixel in which a pixel is shielded from light or a reference voltage output pixel which outputs a reference voltage.

With this configuration, pixel signals outputted from the second pixel can be accurately allowed to be a constant value.

The peripheral part may be placed closer to a periphery of the imaging unit than the valid part is.

In one general aspect, the techniques disclosed here feature an imaging device including: the solid-state imaging device; a digital signal processing unit configured to perform correction processing on a pixel signal in the valid part, which is outputted from the solid-state imaging device; and a storage unit configured to store a pixel signal in the peripheral part, which is outputted from the solid-state imaging device, and correction data generated using the pixel signal in the peripheral part.

With this configuration, an imaging device in which deterioration in the accuracy of the correction data in the pixel-mixture mode is suppressed can be provided.

### Advantageous Effects

A solid-state imaging device according to one or more exemplary embodiments or features disclosed herein can suppress deterioration in accuracy of correction data in a pixel-mixture mode.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram which shows an overall configuration of a solid-state imaging device according to Embodiment 1.

FIG. 2 is a diagram which shows a configuration of pixels shown in FIG. 1.

FIG. 3 is a diagram which shows a configuration of a column circuit unit shown in FIG. 1.

FIG. 4 is a diagram which shows configurations of a multiplexer and a column selection circuit shown in FIG. 1.

FIG. 5 is a diagram which shows a configuration of a row selection circuit shown in FIG. 1.

FIG. 6 is a timing chart which shows an operation to read pixel signals in a valid part in an all-pixel readout mode.

FIG. 7 is a timing chart which shows an operation to read pixel signals in the valid part in a vertical two pixels horizontal two pixels mixture readout mode.

FIG. 8 is a diagram which shows a row selection sequence in the all-pixel readout mode, in which (a) is a diagram showing the number of rows in the pixel unit, while (b) shows a sequence of row address signals provided to each of the rows.

FIG. 9 is a diagram which shows a row selection sequence in the vertical two pixels horizontal two pixels mixture readout mode, in which (a) is a diagram showing the number of rows in the pixel unit, while (b) shows a sequence of row address signals provided to each of the rows.

FIG. 10 is a diagram which shows a row selection sequence in the vertical two pixels horizontal two pixels mixture readout mode in a solid-state imaging device according to Embodiment 2, in which (a) is a diagram showing the number of rows in the pixel unit, while (b) shows a sequence of row address signals provided to each of the rows.

FIG. 11 is a diagram which shows an overall configuration of a solid-state imaging device according to Embodiment 3.

FIG. 12 is a diagram which shows a configuration of a column ADC shown in FIG. 11.

FIG. 13 is a timing chart which shows an operation of the column ADC.

FIG. 14 is a diagram which shows an overall configuration of a solid-state imaging device according to Embodiment 4.

FIG. 15 is a diagram which shows a configuration of a pixel shown in FIG. 14.

FIG. 16 is a diagram which shows details of a row selection circuit shown in FIG. 14.

FIG. 17 is a timing chart which shows a readout operation in the valid part in the all-pixel readout mode.

FIG. 18 is a timing chart which shows a readout operation in the valid part in a vertical 3/5 row pixel thinning mixture mode.

FIG. 19 is a diagram which shows the row selection sequence in the valid part in the vertical 3/5 row pixel thinning mixture mode, in which (a) is a diagram which shows the number of rows in the valid part of the pixel unit, while (b) is a sequence of the row address signals provided to each of the rows.

FIG. 20 is a diagram which shows a row selection sequence in a peripheral part in the vertical 3/5 row pixel thinning mixture mode, in which (a) is a diagram which shows the number of rows in the peripheral part of the pixel unit, while (b) is a sequence of row address signals provided to each of the rows.

FIG. 21 is a diagram which shows a configuration of an imaging device according to Embodiment 5.

FIG. 22 is a flowchart which shows an imaging operation performed by the imaging device shown in FIG. 21.

FIG. 23 is a diagram which shows a configuration of a conventional solid-state imaging device.

### DESCRIPTION OF EMBODIMENT(S)

Hereinafter, embodiments of an imaging device according to the present invention are described, taking a digital still camera as an example, with reference to the drawings. Although the present invention is described with accompanying the below-shown embodiments and the attached drawings, the description aims to exemplification and the present invention is not intended to be limited to the description.

### Embodiment 1

First, description is given to a configuration of an imaging apparatus according to Embodiment 1 of the present invention. In the present embodiment, description is given to a solid-state imaging device driven in a plurality of driving modes, including: an imaging unit including a plurality of pixels arranged two-dimensionally; a row selection circuit which selects a pixel row including pixels among the pixels arranged in a row direction; a column circuit unit configured to temporarily hold pixel signals outputted from the selected pixel row; and a control unit configured to supply a row address signal which designates a pixel row to be selected to the row selection circuit, wherein the pixels include: a plurality of first pixels which output pixel signals dependent on quantity of received light; and a plurality of second pixels which output pixel signals at a constant intensity regardless of the quantity of the received light, the imaging unit includes: a valid part including the first pixels; and a peripheral part including the second pixels which are arranged on a periphery of the valid part, and the control unit is configured to generate and supply, to the row selection circuit, a first row selection sequence including the row address signal which designates the pixel row belonging to the valid part and a second row selection sequence including the row address signal which designates the pixel row belonging to the peripheral part so that the number of pixel rows simultaneously designated in the first row selection sequence and the second row selection sequence or the number of times that each of the pixel rows is designated varies, in at least one of the driving modes. With this, even if the driving mode in the solid-state imaging device is in a pixel-mixture mode in which pixel signals in the valid part are mixed and outputted, pixel signals in the peripheral part are mixed in conformity with the mixture of the pixel signals in the valid part so as to be outputted without being reduced. Therefore, deterioration in accuracy of correction data can be suppressed.

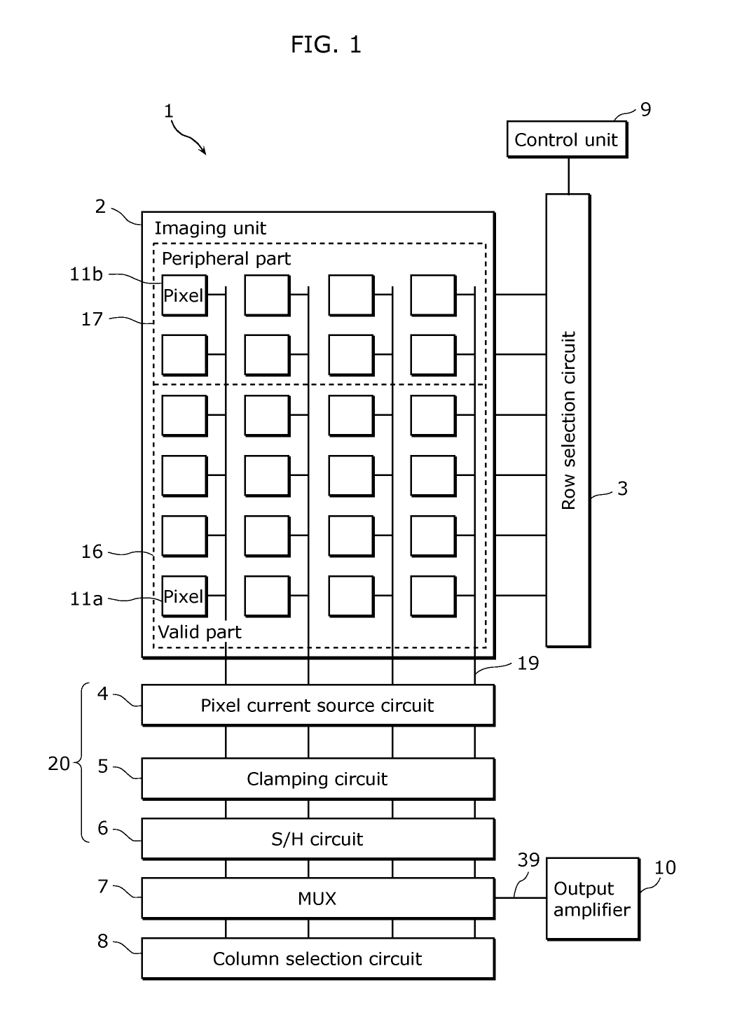

FIG. 1 is a diagram which shows an overall configuration of a solid-state imaging device 1 according to Embodiment 1.

The solid-state imaging device 1 includes an imaging unit 2 in which a plurality of pixels 11a and 11b are arranged two-dimensionally, a row selection circuit 3, a pixel current source circuit 4, a clamping circuit 5, a sample holding (S/H) circuit 6, a multiplexer (MUX) 7, a column selection circuit 8, a control unit 9, an output amplifier 10, a column signal line 19, and a row shared signal line 39.

The imaging unit 2 includes pixel rows made up by the pixels 11a and 11b which are arranged in a row direction. The imaging unit further includes a valid part 16 and a peripheral part 17. In the valid part 16, the pixels 11a each of which performs photoelectric conversion on incident light and outputs a pixel signal dependent on quantity of received light are arranged two-dimensionally. The peripheral part 17 is placed adjacent to the valid part 16 and includes the pixels 11b each of which outputs pixel signals at a constant intensity are arranged. Here, each of the pixels 11b is a light-shielding pixel prepared by preliminarily shielding a pixel from light. It should be noted that the pixel 11b is not limited to the light shielding pixel, but only have to be a reference voltage output pixel which outputs a reference voltage at a constant intensity. The pixel 11a and the pixel 11b respectively correspond to a first pixel and second pixel in the present invention.

Although FIG. 1 shows an example having 24 pixels arranged two-dimensionally including 4 pixels in a row×6 pixels in a column, the total pixel number in practice is several million or more. It should be noted that the peripheral part 17 may be placed not only at a position shown in FIG. 1, but at a position closer to the periphery of the imaging unit 2 than a position where the valid part 16 is placed so as to surround the valid part 16, for example.

The row selection circuit 3 includes three control lines of SEL[n], RST[n], TRAN[n] (n=1, 2, . . . ) for each of pixel rows of the pixels 11a and the pixels 11b which are arranged in the imaging unit 2, and selects the pixels 11a and the pixels 11b in a pixel row unit, to control row selection (selection of a row), reset (initialization), and reading (readout.)

The pixel current source circuit 4 includes reference units 4a for a pixel current source circuit which are arranged in an array for each of columns, and generates current for providing pixel signals outputted from the pixels 11a and the pixels 11b to the clamping circuit 5. The clamping circuit 5 includes reference units 5a for a clamping circuit which are arranged in an array for each of columns, and removes fixed pattern noise components generated in the pixels 11a and the pixels 11b, from the pixel signals outputted by the pixel current source circuit 4 via a column signal line 19. The sample holding circuit 6 includes reference units 6a for a sampling hold circuit which are arranged in an array for each of columns, and holds the pixel signal outputted from the clamping circuit 5. It should be noted that the pixel current source circuit 4, the clamping circuit 5, and the sample holding circuit 6 make up a column circuit unit 20.

The multiplexer 7 switches connection between the sample holding circuit 6 and the output amplifier 10. The column selection circuit 8 includes a column selection signal line 40 and sequentially selects columns in the multiplexer 7. The output amplifier 10 receives, from the multiplexer 7, the output signal outputted from the sample holding circuit 6 via a row shared signal line 39, amplifies the output signal, and outputs the amplified signal.

The control unit 9 provides row address signals ADR for selecting pixels in a pixel row unit to the row selection circuit 3 according to a driving mode in which the solid-state imaging device 1 is driven, and an area of the imaging unit 2 in which readout is performed. To be specific, the control unit 9 generates and provides, to the row selection circuit 3, a first row selection sequence including row address signals corresponding to the valid part 16 and a second row selection sequence including row address signals corresponding to the peripheral part 17 so that the number of pixel rows designated simultaneously in the first row selection sequence and the second row selection sequence, or the number of times that each row is designated differs from each other.

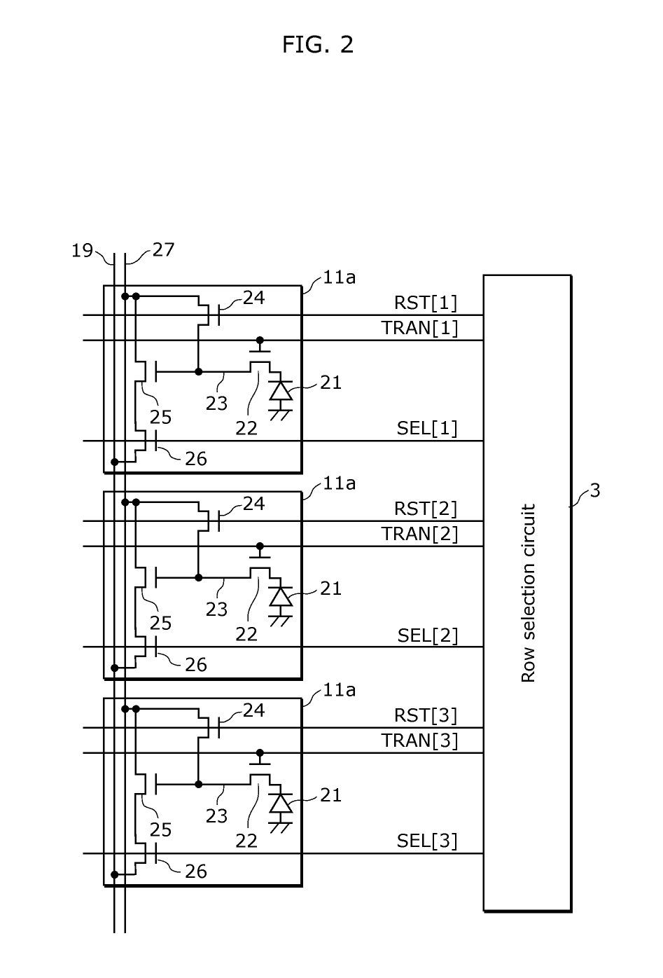

FIG. 2 is a circuit diagram which shows details of the pixels 11a arranged in the valid part 16 in the imaging unit 2. Each of the pixels 11a includes a photodiode (PD) 21 which performs photoelectric conversion on incident light and outputs electric charge, a floating diffusion (FD) 23 which accumulates the electric charge generated in the photodiode 21 and outputs the accumulated electric charge as a voltage signal, a reset transistor (reset Tr) 24 which performs reset so that the voltage indicated by the floating diffusion 23 serves as an initial voltage (VDD in this specification), a transporting transistor (transporting Tr) 22 which supplies the electric charge outputted by the photodiode 21 to the floating diffusion 23, an amplification transistor (amplification Tr) 25 which outputs a voltage varying according to the voltage indicated by the floating diffusion 23, a selection transistor (selection Tr) 26 which supplies, to the column signal line 19, the output from the amplification transistor 25 when the row selection signal is received from the row selection circuit 3, and a power supply line 27 through which a power supply voltage is supplied to a source or a drain of the reset transistor 24 or the amplification transistor 25. It should be noted that pixels 11b have the same configuration with the pixels 11a.

Respective gates of the selection transistor 26, the reset transistor 24, and the transporting transistor 22 are connected to control lines SEL[n], RST[n], and TRAn[n] (n=1, 2, . . . ) so as to receive, from the row selection circuit 3, a row selection signal for selecting a row, a pixel reset signal for performing the reset, and an electrical charge transporting signal for a lead, respectively, and then control of each of the operation is performed.

The pixel 11a in the valid part 16 and the pixel 11b in the peripheral part 17 have the same pixel circuit configuration, except for the fact that the pixel 11b in the peripheral part 17 is a light shielding pixel in which the photodiode 21 is previously shielded from light. As a result, output signals in a dark state are always obtained from the pixels 11b. With this, the pixels 11b output, to the column signal line 19, a reset voltage in which a voltage at initialization is amplified and a lead voltage in which a voltage at readout is amplified.

In addition, each of the pixels 11a shown in FIG. 2 is a unit cell, and has a so-called one-pixel-one-cell configuration that includes the photodiode 21, the transporting transistor 22, the floating diffusion 23, the reset transistor 24, and the amplification transistor 25. Here, the pixels 11a may have a plurality of the photodiodes 21 in a unit cell, and further have a so-called multiple-pixel-one-cell configuration in which any one of the floating diffusion 23, the reset transistor 24, and the amplification transistor 25, or all of them are shared in the unit cell.

In addition, the pixels 11a shown in FIG. 2 can be formed on a surface of the semiconductor substrate, i.e., on a surface in which a gate of the transistor and wiring are placed. The pixels 11a can also be formed on a surface back to the surface in which the gate of the transistor and the wiring are placed. This configuration is referred to as a back-illuminated image sensor (back-illuminated solid-state imaging device) configuration. It should be noted that pixels 11b have the same configuration with the pixels 11a.

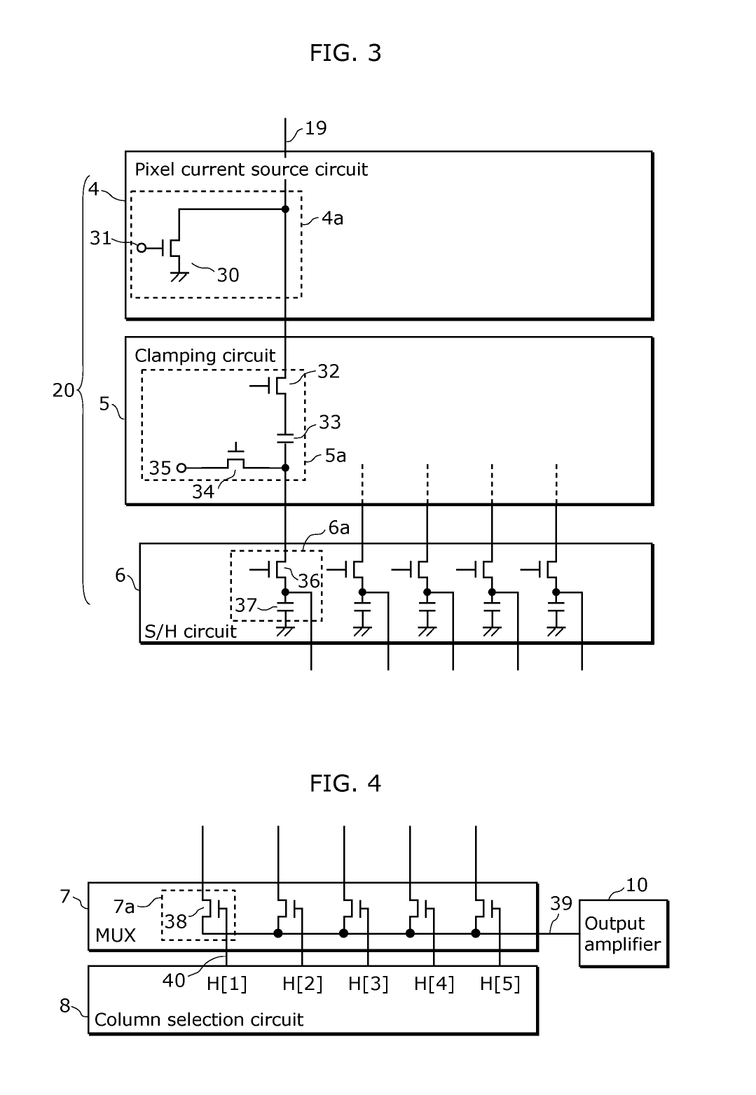

FIG. 3 is a diagram which shows details of a column circuit unit 20, according to Embodiment 1, which includes the pixel current source circuit 4, the clamping circuit 5, and the sample holding circuit 6. The column circuit unit 20 functions to temporarily hold a pixel signal indicated by difference between the reset voltage and the lead voltage which are outputted from the imaging unit 2, and then to output the pixel signal to the multiplexer 7.

To be specific, as shown in FIG. 3, the reference unit 4a of the pixel current source circuit 4 includes a current source transistor 30 which supplies current to the amplification transistor 25 at the time when pixel signal are read from the pixels 11a and 11b, and a bias terminal 31 for supplying a bias potential in the current source to the gate of the current source transistor 30.

Furthermore, as shown in FIG. 3, the reference unit 5a of the clamping circuit 5 includes a sampling transistor 32 which inputs a pixel signal outputted from the pixel current source circuit 4, a clamping capacity 33 (capacity value Ccl) which calculates a pixel signal indicated by the difference between the reset signal and the lead signal from the inputted pixel signal, a clamping voltage input terminal 35 for setting a potential of a terminal opposite to the clamping capacity 33 to be a clamping potential (VCL), and a clamping transistor 34 which switches connections between the clamping capacity 33 and the clamping voltage input terminal 35.

The sample holding circuit 6 has a reference unit 6a for a sample holding circuit in each of columns. The reference unit 6a for a sample holding circuit includes an S/H capacity input transistor 36 that inputs the pixel signal outputted from the clamping circuit 5, and an S/H capacity 37 (capacity value Csh) which temporarily holds the pixel signal. When an S/H capacity input signal is supplied to the S/H capacity input transistor 36, the pixel signal outputted from the clamping circuit 5 is held in the S/H capacity 37.

FIG. 4 shows respective details of the multiplexer 7, the column selection circuit 8, and the output amplifier 10.

As shown in FIG. 4, the multiplexer 7 includes a reference unit 7a for a multiplexer in each of columns. The reference unit 7a for a multiplexer includes the column selection transistor 38 which is connected to the row shared signal line 39. Specifically, the column selection transistor 38 is provided between each of the S/H capacities 37 in the S/H circuit 6 and the row shared signal line 39. The column selection signal H[k] (K=1, 2, . . . ) is supplied to a gate of the column selection transistor 38 from the column selection circuit 8.

With such a configuration, the column selection transistor 38 sequentially outputs, to the row shared signal line 39, pixel signals held in the S/H capacities 37 in the respective columns, according to the column selection signal H[k] supplied to the gate. The signal supplied to the output amplifier 10 via the row shared signal line 39 is amplified, and then outputted to an outside of the solid-state imaging device 1 formed on a chip.

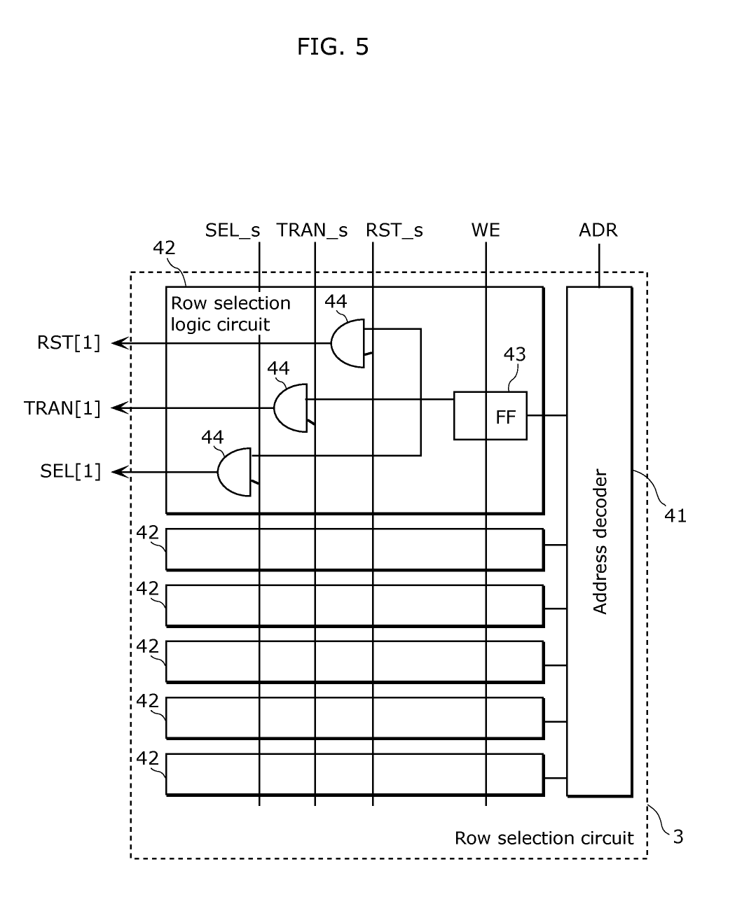

FIG. 5 shows details of the row selection circuit 3. As shown in FIG. 5, the row selection circuit 3 includes an address decoder 41 and a row selection logic circuit 42 provided for each of rows. The address decoder 41 outputs a signal at a Hi (High) level to the row selection logic circuit 42 on a corresponding one of the rows, according to the row address signal supplied from the control unit 9. At the same time, a write enable signal WE of a flip flop (FF) 43 in a corresponding one of the row selection logic circuits 42 is inputted from the control unit 9, to thereby allow the Hi level signal to be set in the flip flop 43, causing the corresponding row to be in a selected state.

Next, when a SEL_s which is a pulse signal, a transistor control signal TRAN_s, a reset signal RST_s which are used for controlling the pixel are inputted to the row selection logic circuit 42 in the row which is in the selected state, respective pulses of the row selection signal, pixel reset signal, and electric charge transporting signal are supplied to the pixel 11a in the selected row from an AND gate 44 in the row selection logic circuit 42 via the control lines SEL[n], TRAN[n], RST[n] (n=1, 2, . . . ). Upon completion of driving the pixels 11a (or the pixels 11b), a value of each flip flop 43 is reset to a signal at a Lo (Low) level, and the row selection is terminated.

Next, the solid-state imaging device 1 according to the present embodiment includes an all-pixel readout mode usable as the driving mode for a still camera photographing and a pixel-mixture mode usable for recording moving pictures. With respect to each of the modes, a readout operation performed in the valid part 16 of the imaging unit 2 is described.

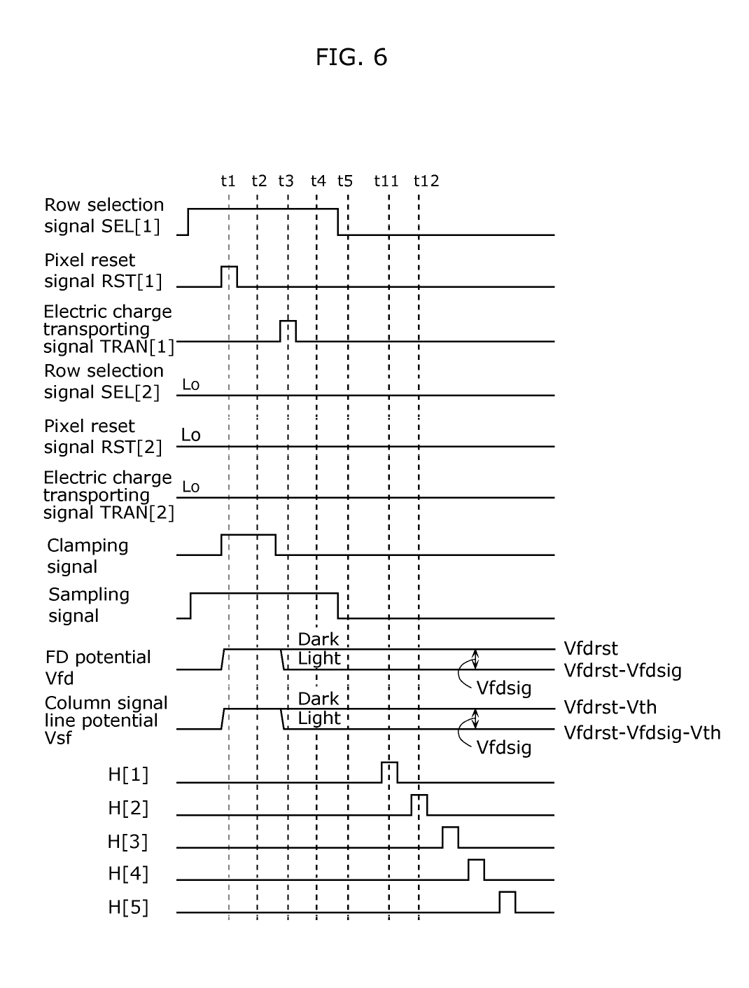

FIG. 6 is a diagram which shows a timing of each of the control signals to be supplied to the imaging unit 2 and the column circuit unit 20 in the readout operation in the valid part 16 in the all-pixel readout mode.

At a timing t1 shown in FIG. 6, the row selection signal supplied to the control line SEL [1] is at the Hi level, and a first one of the pixel rows is selected. The electrical charge transporting signal to be supplied to the control line TRAN [1] is at the Lo level, while the pixel reset signal to be supplied to the control line RST [1] is at the Hi level. Specifically, in the selected first row, the transporting transistor 22 is in the OFF state and the reset transistor 24 is in the ON state in each of the pixels 11a (or pixels 11b), and a potential (hereinafter, referred to as Vfd) of the floating diffusion 23 is initialized to an FD reset potential Vfdrst (=VDD).

At a timing t2, the electric charge transporting signal and the pixel reset signal which are to be respectively supplied to the control line TRAN [1] and the control line RST [1] are at the Lo level. In other words, the transporting transistor 22 and the reset transistor 24 are in the OFF state, so that the reset state of the FD potential is maintained. At this time, the row selection signal to be supplied to the control line SEL [1] is at the Hi level, i.e., the selection transistor 26 is in the ON state. For the occasion, assuming that a threshold voltage of the amplification transistor 25 is set to be Vth, Vfdrst-Vth is outputted to the column signal line 19 as a reset voltage (although the Vfdrst-Vth should strictly be Vfdrst-Vth-α, α is omitted here).

Furthermore, the reset voltage Vfdrst-Vth is outputted to one of terminals of the clamping capacity 33 in the clamping circuit 5 via the column signal line 19. Meanwhile, as shown in FIG. 6, a clamping signal (a gate signal of the clamping transistor 34) and a sampling signal (a gate of the S/H capacity input transistor 36) are both at the Hi level. In other words, the clamping transistor 34 and the S/H capacity input transistor 36 are in the ON state, so that potential of the other terminal of the clamping capacity 33 and potential of the S/H capacity 37 are set to be the clamping potential VCL.

At a timing t3, an electric charge transporting signal to be supplied to the control line TRAN [1] is at the Hi level, i.e., the transporting transistor 22 is in the ON state, so that the electric charge accumulated in the photodiode 21 is transported to the floating diffusion 23. Accordingly, the FD potential Vfd which was the Vfdrst decreases as much voltage as the voltage Vfdsig according to a signal charge amount, resulting in the Vfdrst-Vfdsig.

At a timing t4, an electric charge transporting signal to be supplied to the control line TRAN [1] is at the Lo level, and a row selection signal to be supplied to the control line SEL [1] is at the Hi level, i.e., the transporting transistor 22 is in the OFF state and the selection transistor 26 is in the ON state. Accordingly, the Vfdrst-Vfdsig-Vth is outputted to the column signal line 19 as the lead voltage. This causes the input voltage of the clamping capacity 33 to vary by the voltage corresponding to the Vfdsig.

Furthermore, the clamping signal is at the Lo level, and the clamping transistor 34 is in the OFF state, so that the potential of the other terminal of the clamping capacity 33 (the capacity value: Ccl), i.e., the potential of the S/H capacity 37 (capacity value: Csh) varies by an amount corresponding to Vfdsig×Ccl/(Ccl+Csh). The potential variation is the voltage corresponding to the difference between the reset voltage and the lead voltage in the column signal line 19, i.e., as a pixel signal.

At a timing t5, the sampling signal is at the Lo level, and the pixel signal of the sampling signal is accumulated in the S/H capacity 37. As described above, the pixel signals for a single row is held in the sample holding circuit 6.

Next, at a timing t11, a column selection signal H[1] in the first column in the column selection circuit 8 is at the Hi level, and the column selection transistor 38 in the first column of the multiplexer 7 is in the ON state. With this, the signal outputted from the S/H capacity 37 in the first column is outputted to the row shared signal line 39, and then outputted to the outside via the output amplifier 10.

Similarly, at a timing t12, a column selection signal H[2] in the second column is at the Hi level, and the column selection transistor 38 in the second column of the multiplexer 7 is in the ON state. With this, the signal of the S/H capacity 37 in the second column is outputted to the row shared signal line 39, and then outputted to the outside via the output amplifier 10.

Similarly, signals outputted from the S/H capacity 37 in the respective column are sequentially outputted by allowing the column selection signals in the respective column in the column selection circuit 8 to sequentially be at the Hi level.

As described above, the pixel signals for a single row are sequentially outputted. Furthermore, if the operations shown in FIG. 6 are repeated as many times as the number of rows of the valid part 16 in the imaging unit 2 with sequentially changing the row to be selected from n=1 to n=n, all signals in the valid part 16 for an image corresponding to one screen (one frame) can be read

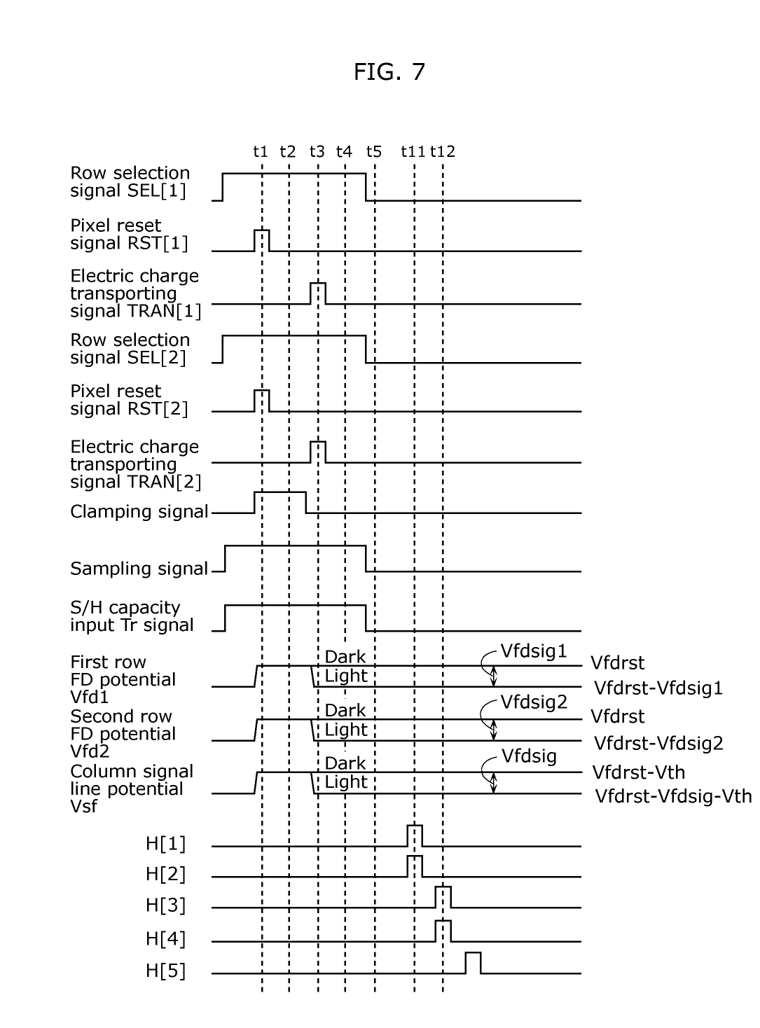

FIG. 7 is a diagram which shows, as an example of the pixel-mixture mode, timings of the control signals to be supplied to the imaging unit 2 and the column circuit unit 20 in the readout operation in the valid part 16 in a vertical two pixels horizontal two pixels mixture readout mode.

At a timing t1 shown in FIG. 7, the row selection signals to be supplied to the control lines SEL[1] and SEL[2] are at the Hi level, and the first and second rows are selected. The electric charge transporting signals to be supplied to the control lines TRAN[1] and TRAN[2] are at the Lo level, and the pixel reset signals to be supplied to the control lines RST[1] and RST[2] are at the Hi level, i.e., the respective transporting transistors 22 in the first and the second rows are in the OFF state and the reset transistor 24 is in the ON state, so that the potential of the floating diffusion 23 (hereinafter, referred to as Vfd) is initialized to an FD reset potential Vfdrst (=VDD). Here, supplying, to two rows, the row selection signal, the electric charge transporting signal, and the pixel reset signal at the same time is enabled by sequentially supplying the row address signals for the respective rows to the address decoder 41 in the row selection circuit 3, and sequentially setting the selection states to the flip flops 43 in the row selection logic circuits 42.

At a timing t2, the electric charge transporting signals and the pixel reset signals to be supplied to the control line TRAN[1] and TRAN[2], the control line RST [1] and RST [2] are at the Lo level, i.e., the transporting transistors 22 and the reset transistors 24 in the first and the second rows are in the OFF state, so that the reset state of the FD potential is maintained. At this time, the row selection signals to be supplied to the control lines SEL[1] and SEL[2] are at the Hi level, i.e., the selection transistors 26 in the first and second rows are in the ON state. Accordingly, the Vfdrst-Vth is outputted to the column signal line 19 as the reset voltage (although the Vfdrst-Vth should strictly be Vfdrst-Vth-α, α is omitted here).

Furthermore, the reset voltage Vfdrst-Vth is outputted to one of terminals of the clamping capacity 33 in the clamping circuit 5 via the column signal line 19. Meanwhile, as shown in FIG. 7, the clamping signal (a gate signal of the clamping transistor 34) and the sampling signal (a gate signal of the S/H capacity input transistor 36) are both at the Hi level. In other words, the clamping transistor 34 and the S/H capacity input transistor 36 are in the ON state, so that the other terminal of the clamping capacity 33 and the potential of the S/H capacity 37 are set to be a clamping potential VCL.

At a timing t3, the electric charge transporting signals to be supplied to the control lines TRAN[1] and TRAN[2] are at the Hi level, i.e., the transporting transistors 22 in the first and second rows are in the ON state, so that the electric charge accumulated in the photodiodes 21 in the first and second rows are transported to the floating diffusion 23. The FD potentials Vfd 1 and Vfd 2 respectively decrease as much voltage as the voltage Vfdsig 1 and Vfdsig 2 which correspond to the respective signal electric charge amounts, and respectively become Vfdrst-Vfdsig 1 and Vfdrst-Vfdsig 2.

At a timing t4, the electric charge transporting signals to be supplied to the control lines TRAN[1] and TRAN[2] are at the Lo level, and the row selection signals to be supplied to the control lines SEL[1] and SEL[2] are at the Hi level. In other words, the transporting transistor 22 is in the OFF state and the selection transistor 26 is in the ON state. When an average of Vfdsig 1 and Vfdsig 2 is set to be Vfdsig, the Vfdrst-Vfdsig-Vth is outputted to the column signal line 19 as the lead voltage. The lead signal corresponds to a mixture signal prepared by mixing signals in the first row and the second row. The potential variation in the column signal line 19 causes the input of the clamping capacity 33 to vary as much voltage as a voltage corresponding to Vfdsig.

The clamping transistor 34 is in the OFF state, so that the potential of the other terminal of the clamping capacity 33, i.e., the potential of the S/H capacity 37, varies as much voltage as an amount corresponding to Vfdsig×Ccl/(Ccl+Csh). The potential variation is a voltage corresponding to the difference between the reset voltage and the lead voltage, i.e., a pixel signal (column pixel mixture signal) obtained by averaging pixel signals in the first and second rows.

At a timing t5, the row selection signal and the sampling signal to be supplied to the control lines SEL[1] and SEL[2] are at the Lo level, so that the vertical mixture pixel signals in the selected first and the second rows are accumulated in the S/H capacity 37.

Next, at a timing t11, the sampling signal is at the Lo level, and the column selection signals H[1] and H[2] in the first and second columns in the column selection circuit 8 are at the Hi level, so that the column selection transistors 38 in the first and second columns in the multiplexer 7 are in the ON state. With this, a pixel signal (column pixel mixture signal) obtained by averaging signals of the respective S/H capacities 37 in the first and second columns is outputted to the row shared signal line 39, and then outputted to the outside via the output amplifier 10. In other words, a vertical two pixels horizontal two pixels mixture signal is outputted which is obtained by mixing pixel signals in the first and second columns in the first and second rows.

Similarly, at a timing t12, column selection signals H[3] and H[4] in the third and fourth columns are at the Hi level, and the column selection transistors 38 in the third and fourth columns of the multiplexer 7 are in the ON state. With this, a row pixel mixture signals in the S/H capacities 37 in the third and fourth columns are outputted to the row shared signal line 39, and the vertical two pixels horizontal two pixels mixture signal obtained by mixing pixel signals in pixels of the third and forth columns in the first and second rows is outputted to the outside via the output amplifier 10.

Similarly, signals of the S/H capacities 37 in the respective columns are sequentially outputted by allowing the column selection signals in the respective columns in the column selection circuit 8 to sequentially be at the Hi level.

As described above, pixel signals obtained by mixing the vertical two pixels and the horizontal two pixels are sequentially outputted. Furthermore, if the operations shown in FIG. 7 are repeated as many times as the half number of rows in the valid part 16 with sequentially changing the selected row from n=1 to n=n, signals in the entire valid part 16 are read with respect to an image for one screen (one frame).

Meanwhile, the clamping potential VCL in the column circuit unit 20 ranges in the horizontal direction, so that the reference potentials in the respective columns are different according to a column. This means that unevenness in the horizontal direction occurs in an output in a dark state which is to be the standard of an image to be outputted. Accordingly, horizontal shading occurs in the image.

In contrast, pixel signals in the pixels 11b in the peripheral part 17, from which the output in the dark state can be always obtained, are read out, and information regarding the pixel signal is used to perform correction at a later stage, to thereby suppress the horizontal shading.

Next, as for the aforementioned two driving modes included in the solid-state imaging device 1 according to the present embodiment, the respective row selection operations are described.

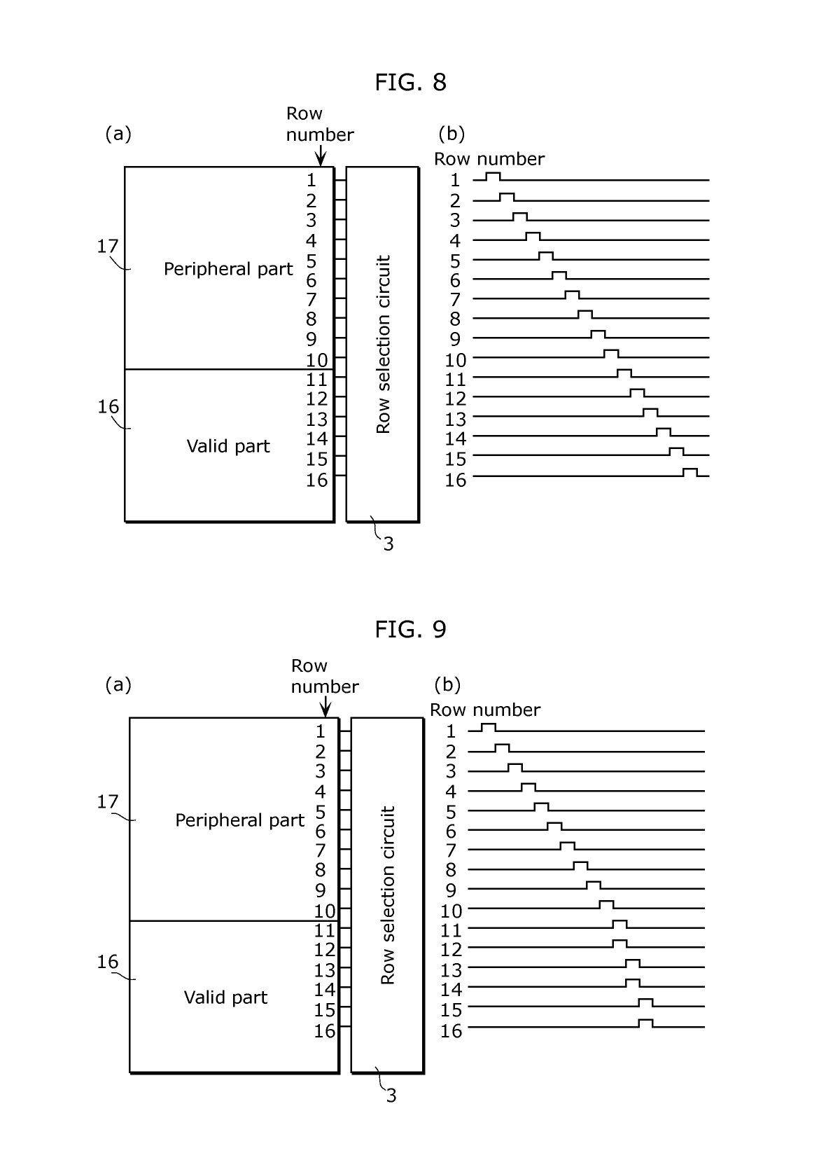

FIG. 8 is a row selection sequence which shows supplying timings of the row address signals to be supplied from the control unit 9 to the row selection circuit 3 in the all-pixel readout mode. FIG. 8 shows the row selection sequence for a single frame period in which pixel signals for a single screen are output, taking the imaging unit 2 having 16 rows as an example. In FIG. 8, (a) shows the row numbers included in the valid part 16 and the peripheral part 17. The row numbers 1 to 10 indicate rows in the peripheral part 17, while the row numbers 11 to 16 indicate rows in the valid part 16. In FIG. 8, (b) shows sequences of the row address signals to be supplied to the respective rows having the row numbers shown in (a). The sequences corresponding to the row numbers 11 to 16 indicate a first row selection sequence, while the sequences corresponding to the row numbers 1 to 10 indicate a second row selection sequence. A period in which a single row address signal is outputted is assumed as a readout period. Since signals except for the row address signals are the same in those shown in FIG. 6, the description of these signals are omitted.

In the all-pixel readout mode, as shown in (b) of FIG. 8, sequences are formed in which a single row address signal is outputted in a single row-readout period both in the first row selection sequence and the second row selection sequence in a single frame period. In other words, a sequence is formed which includes the row address signal used for sequentially designating pixels one-by-one. In accordance with these row selection sequences, the row selection circuit 3 sequentially selects the pixels 11a in the valid part 16 from the row number 11 to the row number 16. In the peripheral part 17, the pixels 11b are selected from the row numbers 1 to 10, like in the valid part 16. With this, the pixel signals in the row numbers same with the physical row numbers of the peripheral part 17, i.e., correction data, can be obtained.

Meanwhile, FIG. 9 shows row selection sequences which indicate supplying timings of the row address signals to be supplied from the control unit 9 to the row selection circuit 3 in the vertical two pixels horizontal two pixels mixture readout mode which is an example of the pixel mixture mode. FIG. 9 shows, similar to FIG. 8, row selection sequences for one frame period in which pixel signals for one screen are output. In FIG. 9, (a) shows, similar to the (a) of FIG. 8, the row numbers in the valid part 16 and the peripheral part 17. The row numbers 1 to 10 indicate rows in the peripheral part 17, while the row numbers 11 to 16 indicate rows in the valid part 16. In FIG. 9, (b) shows sequences of the row address signals to be supplied to the respective rows allocated to the row numbers shown in (a). The sequences corresponding to the row numbers 11 to 16 indicate the first row selection sequence, while the sequences corresponding to the row numbers 1 to 10 indicate the second row selection sequence. Since signals except for the row address signals are the same in those shown in FIG. 7, the description of these signals are omitted.

In the vertical two pixels horizontal two pixels mixture readout mode, as shown in the (b) of FIG. 9, a sequence in which different two row address signals are outputted during a single row-readout period. In other words, a sequence including a row address signal which sequentially designates two pixel rows at the same time is made up. In the second row selection sequence, a sequence is made up in which a single pixel row is designated during a single-row readout period. In other words, a sequence including a row address signal which sequentially designates pixel rows one-by-one. Accordingly, the first row selection sequence and the second row selection sequence are different in the number of rows simultaneously designated. In accordance with these row selection sequences, the row selection circuit 3 selects rows two-by-two from the row number 11 to the row number 16 in the valid part 16, and selects rows one-by-one from the row number 1 to the row number 10 in the peripheral part 17. With this, in the vertical two pixels horizontal two pixels mixture readout mode, the pixel signals in the pixel row numbers same with the physical pixel row numbers in the peripheral part 17, i.e., the correction data, can be obtained. This means that correction data in the large number of rows can be obtained in the pixel-mixture mode like in the all-pixel readout mode, to thereby create correction data for the horizontal shading with high accuracy.

As described above, according to the present embodiment, pixel signals in the peripheral part 17 can be outputted without mixing the pixel signals in accordance with the mixture of the pixel signals in the valid part 16, even in the pixel-mixture mode in which the pixel signals in the valid part 16 are mixed. Accordingly, deterioration in accuracy of the correction data is suppressed without reducing the number of the correction data items obtained from the peripheral part 17, to thereby achieve the pixel-mixture mode with high image quality. In addition, in the present embodiment, the number of the pixel rows in the peripheral part 17 is equal to that in a conventional technique, and the size of a parasitic component of the circuit is also equal to that of a conventional technique. This means that image quality in the pixel-mixture mode can be improved at low power consumption.

The pixel mixture mode is not limited to the mixture of pixel signals in the vertical two pixels and horizontal two pixels. The number of pixels in which pixel signals are mixed may be changed.

The rows or the pixels, in which pixel signals are mixed, need not be the same number between the valid part 16 and the peripheral part 17, and may be the different numbers from each other. For example, a sequence in which three or more row are simultaneously selected may be made up in the first row selection sequence, while a sequence in which two or more rows are simultaneously selected may be made up in the second row selection sequence. Then, the pixel signals in the three rows may be mixed and outputted in the valid part 16 and the pixel signals in the two rows may be mixed and outputted in the peripheral part 17.

### Embodiment 2

Next, Embodiment 2 is described. Embodiment 2 is different from Embodiment 1 in the point that in the vertical two pixels horizontal two pixels mixture readout mode which is one of examples described in Embodiment 1, two or more pixel rows are designated in a single row-readout period, and the Nth pixel row (N is an integer of 1 or more) is designated along with the Mth pixel row (M is an integer of 1 or more, and M is not equal to N) during a single row-readout period and pixel rows are designated more than once with the value of M being changed in a single frame period. A circuit configuration of a solid-state imaging device, a readout operation in a valid part, and a readout operation in a peripheral part in an all-pixel readout mode are the same with those in Embodiment 1.

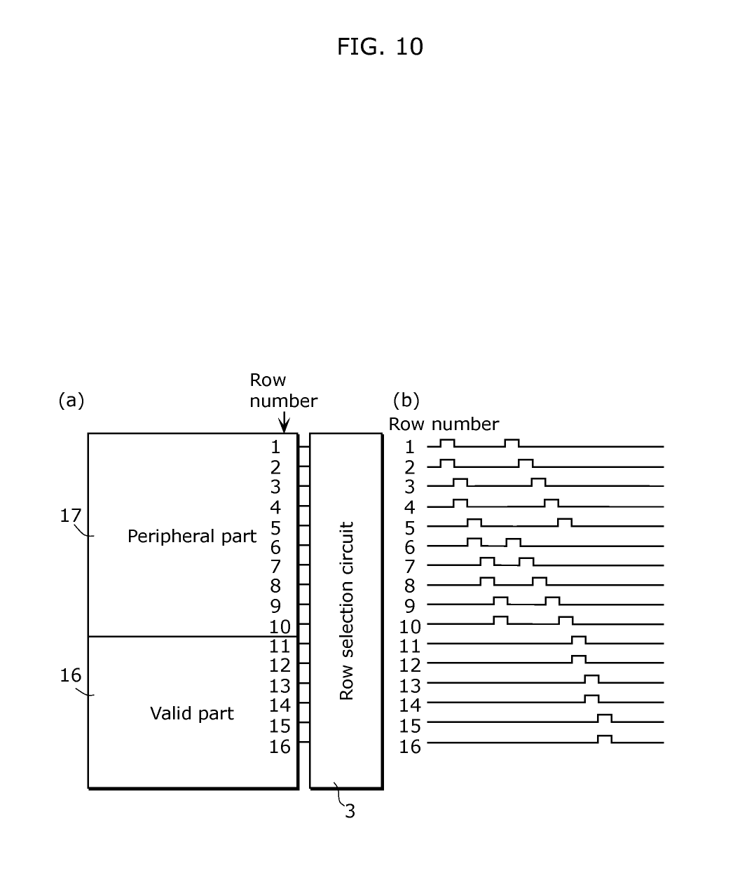

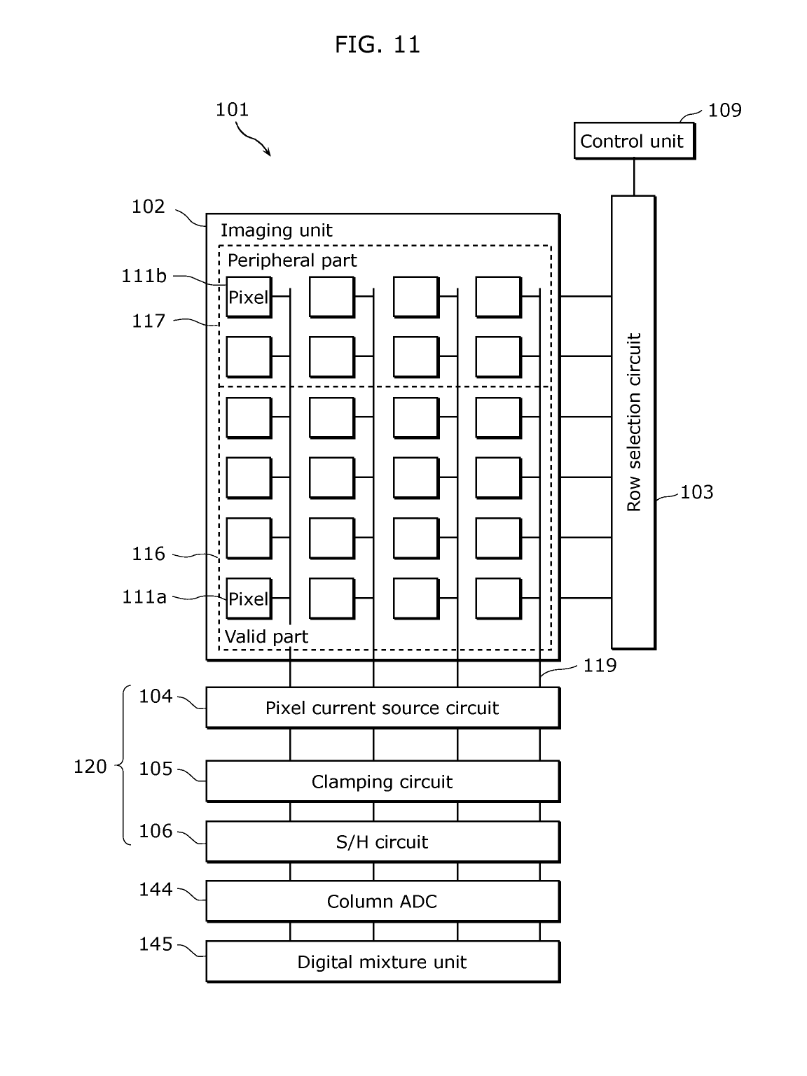

FIG. 10 shows row selection sequences which indicate supplying timings of row address signals to be supplied from a control unit 9 to a row selection circuit 3 in the vertical two pixels horizontal two pixels mixture readout mode. FIG. 10 shows row selection sequences for a single frame period in which pixel signals for a single screen are outputted, taking an imaging unit 2 having 16 rows as an example, like in FIG. 8. In FIG. 10, (a) shows the row numbers N and M. The Nth pixel row (N is an integer of 1 or more) and the Mth pixel row (M is 1 or more e and M is not equal to N) respectively indicate one of pixel rows in the valid part 16 and one of pixel rows in the peripheral part 17. The row numbers 1 to 10 indicate rows in the peripheral part 17, while the row numbers 11 to 16 indicate rows in the valid part 16. In FIG. 10, (b) shows sequences of the row address signals to be supplied to the rows allocated to the respective row numbers shown in (a). The sequences corresponding to the row numbers 11 to 16 indicate a first row selection sequence, while the sequences corresponding to the row numbers 1 to 10 indicate a second row selection sequence.

As shown in the (b) in FIG. 10, in the peripheral part 17, the first pixel row (N=1) is designated along with the second pixel row (M=2) in accordance with the row selection sequence in a single row-readout period. In other words, the row number 1 and the row number 2 are selected at the same time. Subsequently, the row numbers 3 and 4, the row numbers 5 and 6, and the row numbers 7 and 8 are respectively selected.

Next, in the same single frame period, the first pixel row (N=1) is designated along with a sixth pixel row (M=6) during different single row-readout periods. In other words, the row number 1 and the row number 6 are selected at the same time. Here, this is the second selection on the row number 1. Although the row number 2 is selected at the same time with the row number 1 in the first selection on the row number 1, the row number 6 is selected at the same time with the row number 1 in the second selection on the row number 1. This shows that the row to be combined with the selection on the row number 1 differs between the first selection and the second selection. In the similar manner, the row numbers 2 and 7, the row numbers 3 and 8, the row numbers 4 and 9, and the row numbers 5 and 10 are respectively selected. As a result, even if two rows are simultaneously designated in the peripheral part 17 having 10 rows, pixel signals for 10 rows can be obtained as correction data.

Then, the row numbers 11 and 12, the row numbers 13 and 14, and the row numbers 15 and 16 are sequentially selected according to the first row selection sequence, and pixel signals in the valid part 16 are readout, in the same manner as in the row selection sequence according to Embodiment 1, which is shown in FIG. 9. As a result, each of rows is selected once in the first row selection sequence, while the each of row selected twice in the second selection sequence. In the peripheral part 17, pixel signals same in the number of pixel signals in the peripheral part 17 which are read from rows one-by-one can be obtained.

With such a sequence, the correction data for horizontal shading can be created with high accuracy, to thereby achieve the mixture mode with high image quality. In addition, the numbers of rows designated at the same time upon the respective readout from the valid part 16 and the readout from the peripheral part 17 are the same. Accordingly, there is no concern about offset to be occur in outputs from the valid part 16 and the peripheral part 17 due to difference in driving modes, to thereby achieve an advantage that correction processing in a later stage is more simplified.

Although pixel signals in two pixel rows are mixed and designated twice in the present embodiment, the number of rows to be mixed and the number of times that each of the pixel signals is designated may be changed. For example, pixel signals for three pixel rows may be mixed and designated three times.

### Embodiment 3

Next, Embodiment 3 is described. Embodiment 3 is different from Embodiment 1 in the point that Embodiment 3 includes a column ADC and a digital mixture unit instead of the multiplexer and the column selection circuit which are described in Embodiment 1.

FIG. 11 is a diagram which shows an overall configuration of a solid-state imaging device according to Embodiment 3. As shown in FIG. 11, a solid-state imaging device 101 according to the present embodiment includes an imaging unit 102, a row selection circuit 103, a pixel current source circuit 104, a clamping circuit 105, a sample holding (S/H) circuit 106, a column ADC 144, a digital mixture unit 145, a control unit 109, and a column signal line 119. It should be noted that the pixel current source circuit 104, the clamping circuit 105, and the sample holding circuit 106 make up a column circuit unit 120. In addition, an output unit (output amplifier) is not shown in FIG. 11.

The column ADC 144 includes reference units 144a of the column ADC 144 which are arranged in an array in a column direction, and converts analog pixel signals in a row unit which are held in the sample holding circuit 106 into digital signals.

The digital mixture unit 145 includes reference units (not shown) of the digital mixture unit which are arranged in an array in a column direction, and mixes output data from the column ADC 144.

The imaging unit 102, the pixel current source circuit 104, the clumping circuit 105, the sample holding circuit 106, the row selection circuit 103, and the control unit 109 are configured in the same manner as those in Embodiment 1. Accordingly, description of these units is omitted. It should be noted that the imaging unit 102 includes a valid part 116 with pixels 111a which output pixel signals according to received light quantity and are arranged two-dimensionally, and a peripheral part 117 with pixels 111b which are light-shielding pixels and from which outputs are always in a dark state. The pixel 111a and the pixel 111b respectively correspond to a first pixel and a second pixel in the present invention.

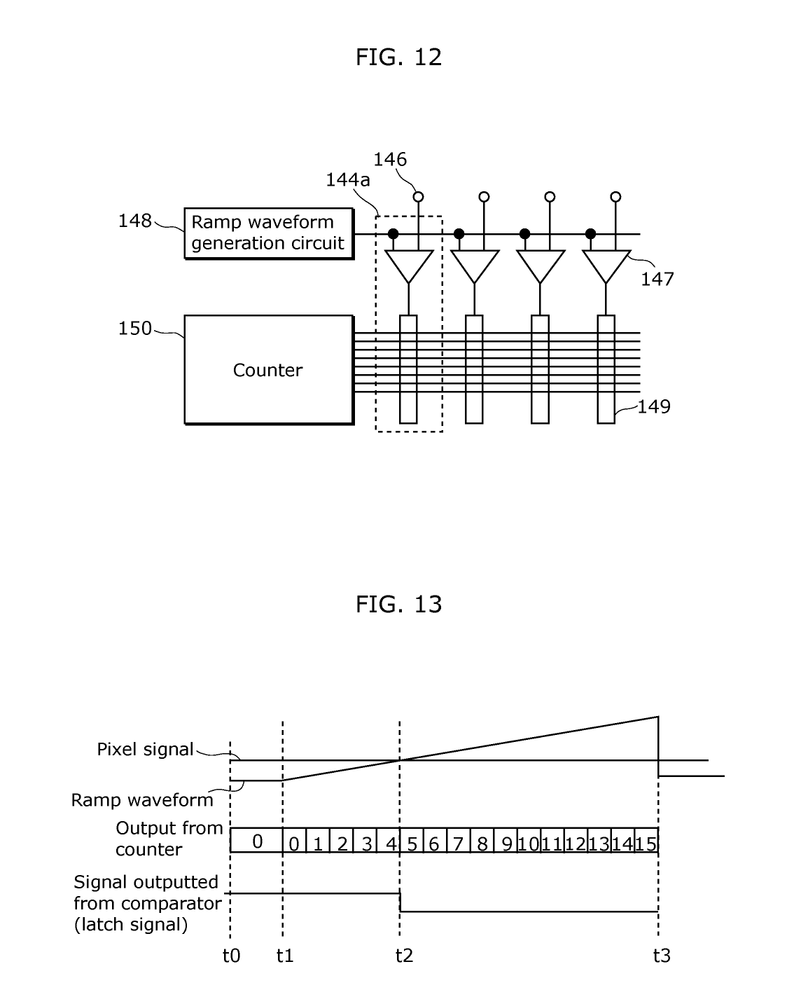

FIG. 12 is a diagram which shows a configuration of the column ADC 144. The column ADC 144 includes a column ADC input terminal 146, a comparator 147, a ramp waveform generation unit 148, a latch 149, and a counter 150. For each of the column signal lines 119, the reference unit 144a of the column ADC is provided.

A pixel signal which is inputted to the column ADC input terminal 146 from the sampling hold circuit 106 is inputted to the comparator 147.

The comparator 147 compares a ramp waveform generated by the ramp waveform generation circuit 148 with the pixel signal. When the ramp waveform is lower than the pixel signal, a latch signal at a Hi level is outputted.

The latch 149 includes a reference unit according to the bit number of a digital value which has undergone the AD conversion. To the reference unit, an output from the counter 150 is inputted. When the latch signal from the comparator 147 is switched from a Hi level to a Lo level, the output from the counter 150 is written in the latch 149. The counter 150 counts up in synchronization with the ramp waveform.

The digital mixture unit 145 mixes pixel signals in a plurality of columns, which have undergone the AD conversion in the reference unit 144a of the column ADC 144 in each of columns. With this, a mixed pixel signal of the digital value in which pixel signals in rows and columns are mixed.

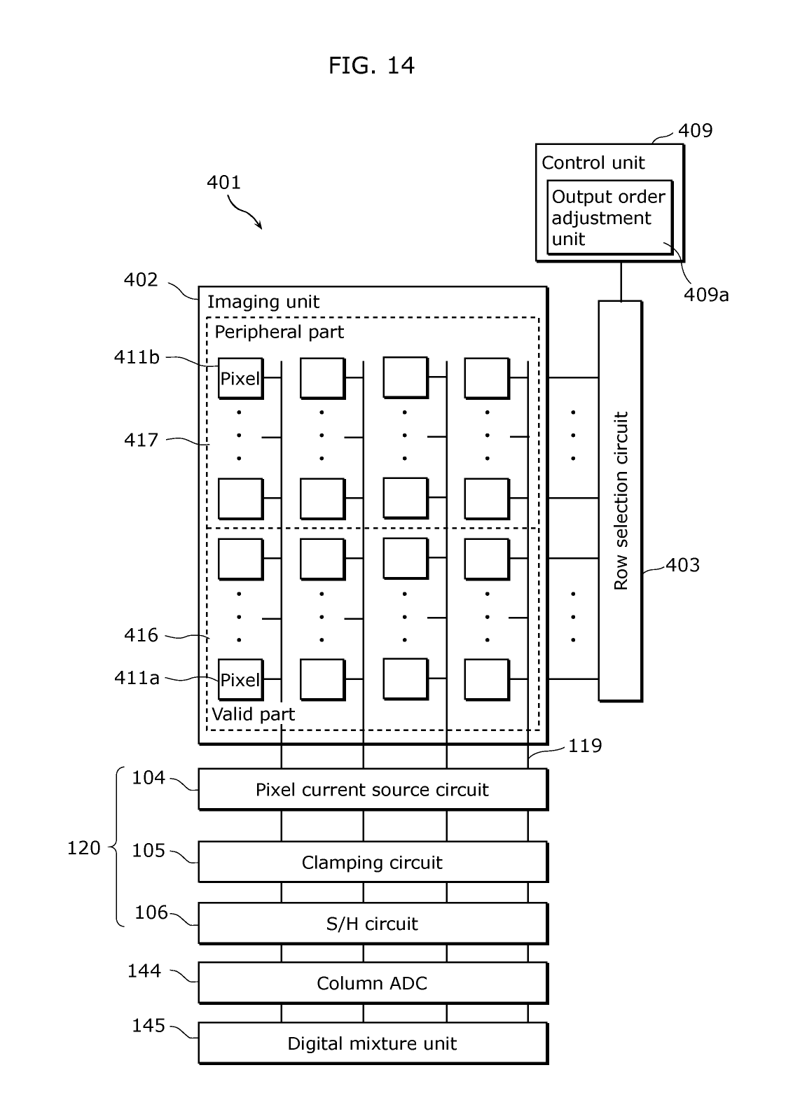

Next, an AD conversion operation in the column ADC 144 is described with reference to a timing chart shown in FIG. 13.

First, at a timing t0 shown in FIG. 13, a pixel signal is inputted to the column ADC input terminal 146 in the column ADC 144, and the ramp waveform outputted from the ramp waveform generation circuit 148 is set to a minimum value of a pixel signal, and a counter value of the counter 150 is set to 0. As shown in FIG. 13, the ramp waveform is at a lower level than that of the pixel signal, so that a latch signal outputted from the comparator 147 is at the Hi level.

Next, at a timing t1, a level of the ramp waveform starts to increase. Inclination of the increase is set so that the pixel signal achieves the maximum value at the timing t3. The counter value of the counter 150 is made to count up in synchronization with the increase in the ramp waveform.

At a timing t2, the ramp waveform is larger than the pixel signal, so that the level of the latch signal switches to the Lo level, and the counter value for the occasion is written into the latch 149. For example, 4 is written as the counter value in the case shown in FIG. 13. As described above, the increase in the ramp waveform and the count-up of the counter 150 synchronize with each other, so that the counter value (digital value) written in the latch 149 is a value which corresponds to the intensity of a pixel signal.

The operations described in the above are performed in parallel in the reference units 144a in the column ADC 144 which are provided in the respective columns. Analog pixel signals for a single row are subjected to the AD conversion in parallel, and the digital signals are held in the latch 149 in each of columns.

The solid-state imaging device 101 in the present embodiment includes, as a driving mode, an all-picture readout mode for taking still pictures and a pixel-mixture mode for taking moving pictures. Next, with respect to the respective driving modes, a readout operation in the valid part 116 is described.

In the all-picture readout mode, as in Embodiment 1, pixel signals for a single row are first readout from the imaging unit 102, and held in the sample holding circuit 106. Next, the pixel signals for the single row are subjected to the AD conversion in the column ADC 144. Lastly, these digital signals are subsequently outputted to the outside of a chip via an output unit which is not shown in FIG. 11. By repeating the operations described above as many times as the number of rows in the valid part 116, pixel signals are outputted from the pixels 111a in the entire imaging unit 102.

Also in the pixel-mixture mode, as in Embodiment 1, two rows are first selected at the same time in the imaging unit 102, pixel signals of the pixels 111b are read for two rows, and the mixed pixel signals for two rows, which are mixed in the column signal line 119, are held in the sample holding circuit 106. Next, the mixed pixel signals are subjected to the AD conversion in the column ADC 144.

Subsequently, pixel signals (digital values) for two columns are mixed in the digital mixture unit 145. Lastly, these mixed pixel signals are subsequently outputted to the outside of a chip via an output unit which is not shown in FIG. 12. By repeating the operations described above as many times as the half number of pixel rows in the valid part 116, pixel signals in the entire imaging unit 102 are outputted.

Meanwhile, a clamping potential in the column circuit unit 120 ranges in the horizontal direction, so that reference potentials in the respective columns are different according to a column. This means that unevenness in the horizontal direction occurs in an output in a dark state, which is the standard of an output image. Accordingly, horizontal shading occurs in an image.

In contrast, pixel signals (pixels 111b) in the peripheral part 117, from which an output in a dark state can always be obtained, are read, and information regarding the pixel signals is used to perform correction at a later stage, to thereby suppress the horizontal shading.

With respect to the aforementioned two driving modes which are included in the solid-state imaging device 101 according to the present embodiment, the respective readout operations in the peripheral part 117 are described.

In the all-pixel readout mode, as shown in FIG. 8 for Embodiment 1, the pixels 111b from which pixel signals are read out are sequentially selected from the row number 1 in the peripheral part 117 as in the valid part 116. With this, the correction data in the row numbers same with the physical row numbers of the peripheral part 117 can be obtained.

In contrast, in vertical two pixels horizontal two pixels mixture readout mode, as shown in FIG. 9 for Embodiment 1, two rows are selected at the same time in the valid part 116, while rows are selected one-by-one starting from the row number 1 in the peripheral part 117. With this, pixel signals in the row numbers same with the physical row numbers in the peripheral part 117, i.e., correction data, can be obtained. This means that the correction data in the large number of rows can be obtained, and create a horizontal shading correction data with high accuracy also in the pixel-mixture mode as in the all-pixel readout mode. Accordingly, a pixel mixture mode with high image quality can be achieved.

It should be noted that the correction in the horizontal shading may be performed under a condition that a digital signal processor is installed in a solid-state imaging device.

### Embodiment 4

Next, Embodiment 4 is described. Embodiment 4 is different from Embodiment 1 in the point that the control unit described in Embodiment 1 includes an output order adjustment unit in Embodiment 4. In addition, in Embodiment 4, there are provided a column ADC and a digital mixture unit respectively instead of the multiplexer and the column selection circuit which are described in Embodiment 1. Furthermore, in Embodiment 4, the pixels 411a and 411b referred to in Embodiment 1 have a vertical four pixels one cell configuration (unit row is four), and the driving mode is a vertical 3/5 row pixel thinning mixture mode.

FIG. 14 is a diagram which shows an overall configuration of a solid-state imaging device according to Embodiment 4.

First, description is given to a configuration of an imaging apparatus according to Embodiment 4. In the present embodiment, description is given to a solid-state imaging device driven in a plurality of driving modes, including: an imaging unit including a plurality of pixels arranged two-dimensionally; a row selection circuit which selects a pixel row including pixels among the pixels arranged in a row direction; a column circuit unit configured to temporarily hold pixel signals outputted from the selected pixel row; and a control unit configured to supply a row address signal which designates a pixel row to be selected to the row selection circuit, in which the pixels include: a plurality of first pixels which output pixel signals dependent on quantity of received light; and a plurality of second pixels which output pixel signals at a constant intensity regardless of the quantity of the received light, the imaging unit includes: a valid part including the first pixels; and a peripheral part including the second pixels which are arranged on a periphery of the valid part, in at least one of the driving modes, the control unit includes an output order adjustment unit configured to adjust an output order of row address signals including the row address signal, the output order adjustment unit is configured to adjust the output order of the row address signals so that orders and combinations of the numbers of rows to be outputted per unit row are equal to each other in a first row selection sequence and in a second row selection sequence, and generate the first row selection sequence including the row address signal which designates the pixel row belonging to the valid part and the second selection sequence including the row address signal which designates the pixel row belonging to the peripheral part, and the control unit is configured to supply, to the row selection circuit, the first row selection sequence and the second row selection sequence which have been adjusted in terms of the output order of the row address signals. With this, even if the driving mode of the solid-state imaging device is a pixel thinning mixture mode in which pixel signals in a valid part are thinned out and mixed so as to be outputted, pixel signals in a peripheral part can be outputted without being reduced in the number along with the pixel signals in the valid part which are thinned out and mixed. In addition, it is possible to suppress deterioration in accuracy of correction data due to variation in output offset in a unit row unique to a multiple pixels one cell configuration.

A solid-state imaging device 401 includes an imaging unit 402 in which a plurality of pixels 411a and 411b are arranged two-dimensionally, a row selection circuit 403, a pixel current source circuit 104, a clamping circuit 105, a sample holding (S/H) circuit 106, a column ADC 144, a digital mixture unit 145, a control unit 409, and a column signal line 119. It should be noted that the pixel current source circuit 104, the clamping circuit 105, and the sample holding circuit 106 make up a column circuit unit 120.

The column ADC 144 includes reference units (see FIG. 12) thereof which are arranged in an array in a column direction, and converts, to digital signals, analog pixel signals in a row unit which are held in the sample holding circuit 106.

The digital mixture unit 145 includes reference units (not shown) thereof which are arranged in an array in the column direction, and mixes output data from the column ADC 144.

The imaging unit 402 includes the pixels 411a and 411b which are arranged in a row direction and make up pixel rows. The imaging unit 402 also includes a valid part 416, and a peripheral part 417. In the valid part 416, the pixels 411a each of which performs photoelectric conversion on incident light and outputs a pixel signal dependent on quantity of received light are arranged two-dimensionally. The peripheral part 417 is placed adjacent to the valid part 416 and includes the pixels 411b each of which outputs pixel signals at a constant intensity. Here, the pixels 411b are light shielding pixels prepared by preliminarily shielding a pixel from light. It should be noted that the pixel 411b is not limited to the light shielding pixel, but may be a reference voltage output pixel which outputs a reference voltage at a constant intensity. The pixel 411a and the pixel 411b respectively correspond to a first pixel and second pixel in the present invention.

With reference to FIG. 14, total 36×4 pixels arranged two-dimensionally having 16×4 pixels in the peripheral part and 20×4 pixels in the valid part are described as an example. The practical number of total pixels is several million or more. It should be noted that the peripheral part 417 may be placed not only at a position shown in FIG. 14, but at a position closer to the periphery of the imaging unit 2 than a position where the valid part 416 is placed so as to surround the valid part 416, for example.

The row selection circuit 403 includes three control lines, such as a control line TRAN[n] (n=1, 2, . . . ) for respective pixel rows of the pixels 411a and the pixels 411b located in the imaging unit 402, and control lines SEL[m] and RST[m] (m=(n−1)/4+1, m=1, 2, . . . ) for each unit pixel row, selects each of the pixels 411a and each the pixels 411b in a pixel row unit, and controls row selection (selection on a row), reset (initialization), and reading (readout).

The control unit 409 supplies, to the row selection circuit 403, a row address signal ADR with which the pixel 411a and 411b are selected in the pixel row unit according to a driving mode for driving the solid-state imaging device 401 and an area of the imaging unit 402 where the readout is performed. To be specific, the control unit 409 generates and supplies to the row selection circuit 403, a row address signal so that a first row selection sequence including a row address signal corresponding to the valid part 416 and a second row selection sequence including a row address signal corresponding to the peripheral part 417 are identical to each other in an order of rows to be outputted and combination of rows in a unit row.

The pixel current source circuit 104, the clamping circuit 105, and the sample holding circuit 106 are same as those in Embodiment 1 in their configuration, and the column ADC 144, the digital mixture unit 145 are same as those in Embodiment 3 in their configuration. Accordingly, description of these components is omitted.

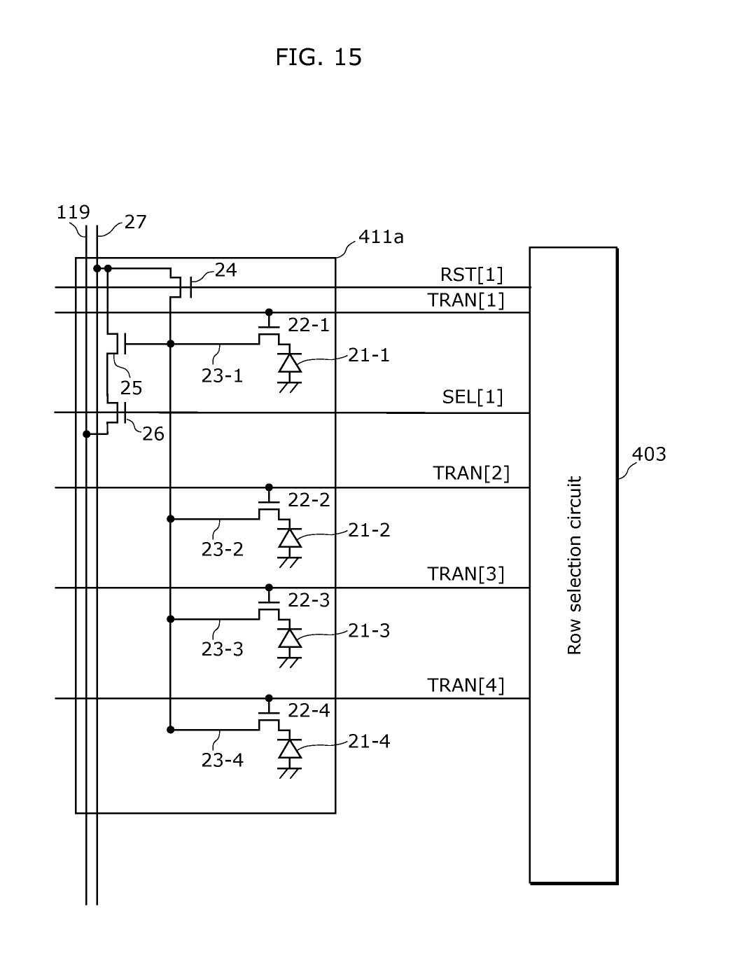

FIG. 15 is a circuit diagram which shows details of one of the pixels 411a arranged in the valid part 416 in the imaging unit 402. The pixel 411a includes four photodiodes 21-1 to 21-4 in a unit cell, and has a so-called vertical four pixels one cell configuration in which a part of floating diffusions 23-1 to 23-4, a reset transistor 24, and an amplification transistor 25 are shared in a unit cell. To be specific, as shown in FIG. 15, the pixel 411a includes the photodiodes (PD) 21-1 to 21-4, floating diffusions (FD) 23-1 to 23-4, a reset transistor (reset Tr) 24, transporting transistors (transporting Tr) 22-1 to 22-4, an amplification transistor (amplification Tr) 25, a selection transistor (selection Tr) 26, and a power source line 27. The photodiodes (PD) 21-1 to 21-4 perform photoelectric conversion on incident light and output an electric charge. The floating diffusions (FD) 23-1 to 23-4 accumulate the electric charge generated in the photodiodes 21-1 to 21-4, and output the accumulated electric charge as voltage signals. The reset transistor (reset Tr) 24 performs reset so that voltages indicated in the floating diffusion 23-1 to 23-4 to serve as an initial voltage (VDD in this specification). The transporting transistors (transporting Tr) 22-1 to 22-4 supply the electric charge outputted from the photodiodes 21-1 to 21-4 to the floating diffusion 23-1 to 23-4. The amplification transistor (amplification Tr) 25 outputs voltages varying along with the voltages indicated by the floating diffusions 23-1 to 23-4. The selection transistor (selection Tr) 26 supplies the output from the amplification transistor 25 to the column signal line 119 when receiving a row selection signal from the row selection circuit 403. The power source line 27 used for supplying a power source voltage to a source or a drain of each of the reset transistor 24 and the amplification transistor 25. It should be noted that pixels 411b have the same configuration with the pixels 411a.

Each of gates of the selection transistor 26, reset transistor 24, transporting transistors 22-1 to 22-4 is connected to a corresponding one of the control lines SEL[m], RST[m] (m=(n−1)/4+1, m=1, 2, . . . ) and TRAN[n] (n=1, 2, . . . ), and receives, from the row selection circuit 403, a row selection signal for the row selection, a pixel reset signal for the reset, and an electric charge transporting signal for the leading, to thereby perform control on each of operations.

Although the pixel 411a in the valid part 416 and the pixel 411b in the peripheral part 417 are identical in the pixel circuit configuration, the pixel 411b in the peripheral part 417 is a light shielding pixel in which the photodiodes 21-1 to 21-4 are preliminarily shielded from light. As a result, from the pixel 411b, output signals which are always in a dark state can be obtained. With this, the pixels 411b output, to the column signal line 119, a reset voltage in which a voltage at initialization is amplified and a lead voltage in which a voltage at readout is amplified are outputted.

In addition, the pixel 411a shown in FIG. 15 can be formed on a surface of a semiconductor substrate, i.e., on a surface in which a gate of a transistor and wiring are placed. The pixels 411a can be also formed on a surface back to the surface in which the gate of the transistor and the wiring are placed, which is so-called a back-illuminated imaging sensor (back-illuminated solid-state imaging device) configuration. It should be noted that pixels 411b have the same configuration with the pixels 411a.

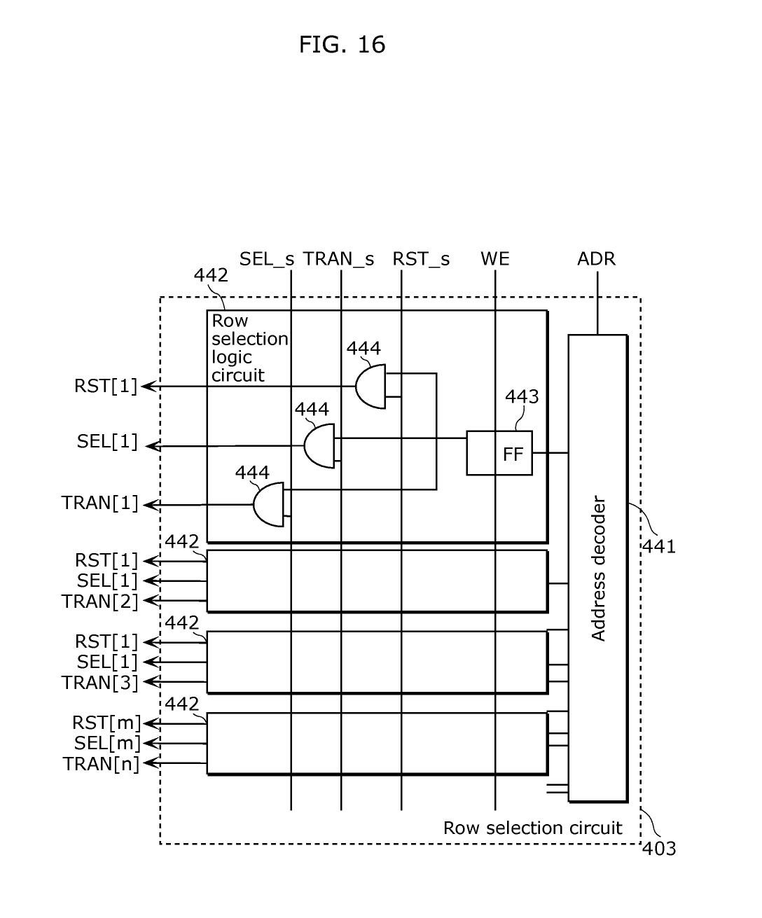

FIG. 16 shows details of the row selection circuit 403. As shown in FIG. 16, the row selection circuit 403 includes, an address decoder 441, and a row selection logic circuit 442 arranged for each of rows. The address decoder 441 outputs a signal at a Hi (High) level to the row selection logic circuit 442 in a corresponding one of the rows, according to the row address signal supplied from the control unit 409. At the same time, a write enable signal WE of a flip flop (FF) 443 in a corresponding one of the row selection logic circuits 442 is inputted from the control unit 409, to thereby set a signal at the Hi level in the flip flop 443. This causes the corresponding row to be in a selected state.

Next, when a pulse signal SEL_s for controlling pixels, a transistor control signal TRAN_s, a reset signal RST_s are inputted to the row selection logic circuit 442 which is in the selection state, pulses of the respective row selection signal, pixel reset signal, and electric charge transporting signal are supplied to the pixels 411a in the selected rows from AND gates 444 of the row selection logic circuits 442 via the respective control lines SEL[m], RST[m] (m=(n−1)/4+1, m=1, 2, . . . ), and TRAN[n] (n=1, 2, . . . ). Upon completion of the driving of the pixels 411a (or the pixels 411b), a value of the flip flop 443 is reset to a signal at the Lo (Low) level, and the row selection is terminated.

The solid-state imaging device 401 in the present embodiment includes, as driving modes, an all-pixel readout mode for taking still pictures and a pixel thinning mixture mode (3/5 row pixel thinning mixture mode) for taking moving pictures. Next, with respect to the respective driving modes, a signal-readout operation in the valid part 416 is described.

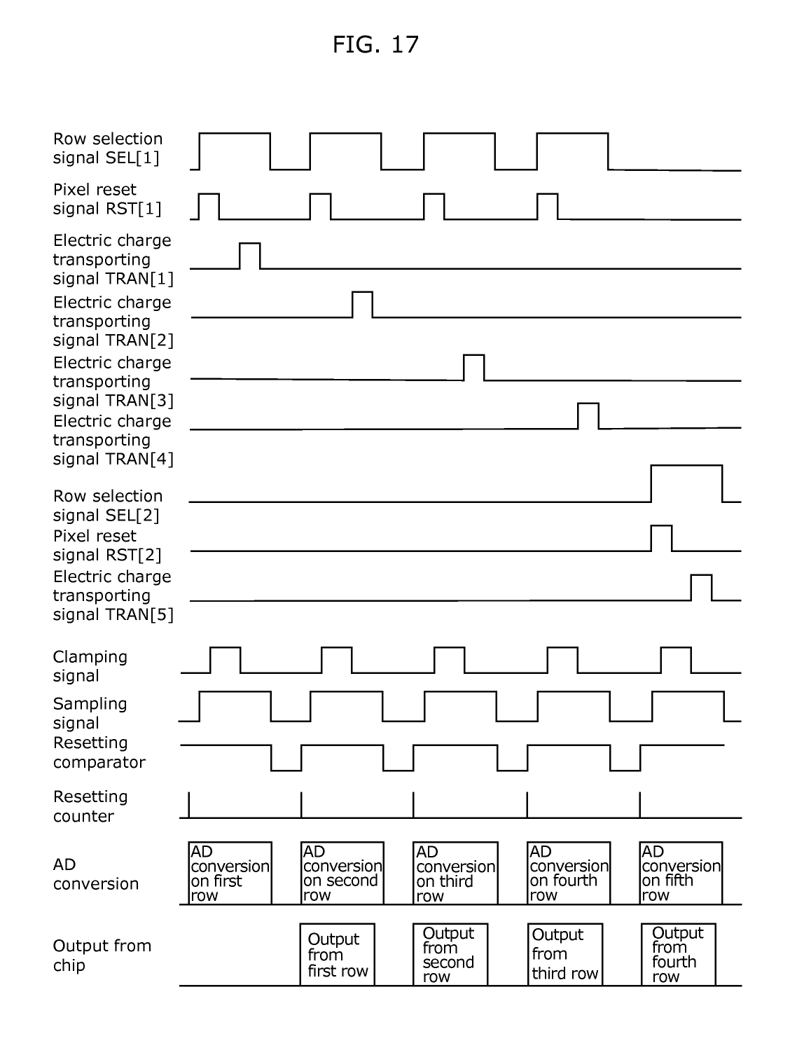

FIG. 17 is a diagram which shows a timing of each of control signals supplied to the imaging unit 402 and the column circuit unit 120 in the readout operation in the valid part 416 in the all-picture readout mode.

In the all-picture readout mode, as in Embodiment 1, pixel signals for a single row are first readout from the imaging unit 402, and held in the sample holding circuit 106. Next, the pixel signals for the single row are subjected to the AD conversion in the column ADC 144. Lastly, these digital signals are subsequently outputted to the outside of a chip via an output unit which is not shown in FIG. 14.

To be specific, as shown in FIG. 17, the row selection signal supplied to the control line SEL[1] becomes at the Hi level, and a first row is selected. Furthermore, the pixel reset signal and the electric charge transporting signal respectively supplied to a control line RST[1] and a control line TRAN[1] become at the Hi level, and the transporting transistor 22-1 in the pixel 411a in the first row is in the ON state, and then an electric charge generated in the photodiode 21-1 is transported to the floating diffusion 23-1.

Subsequently, the row selection signal supplied to the control line SEL[1] becomes at the Hi level, and the first row is selected. Furthermore, the pixel reset signal and the electric charge transporting signal respectively supplied to the control line RST[1] and a control line TRAN[2] become at the Hi level, and the transporting transistor 22-2 in the pixel 411a in the first row is in the ON state, and then the electric charge generated in the photodiode 21-2 is transported to the floating diffusion 23-2.

Subsequently, the row selection signal supplied to the control line SEL[1] becomes at the Hi level, and the first row is selected. Furthermore, the pixel reset signal and the electric charge transporting signal respectively supplied to the control line RST[1] and a control line TRAN[3] become at the Hi level, and the transporting transistor 22-3 in the pixel 411a in the first row is in the ON state, and then the electric charge generated in the photodiode 21-3 is transported to the floating diffusion 23-3.

Similarly, the row selection signal to be supplied to the control line SEL[1] becomes at the Hi level, and the first row is selected. Furthermore, the pixel reset signal and the electric charge transporting signal respectively supplied to the control line RST[1] and a control line TRAN[4] become at the Hi level, and the transporting transistor 22-4 in the pixel 411a in the first row is in the ON state, and then the electric charge generated in the photodiode 21-4 is transported to the floating diffusion 23-4.

Along with the transportation of the electric charge generated in each of the photodiodes 21-1 to 21-4, a clamping signal, a sampling signal, a comparator reset signal, a counter reset signal, and a control signal for the AD conversion which are shown in FIG. 17 are become at the Hi level at the respective timings, and digital signals are sequentially outputted to the outside of a chip via an output unit which is not shown in FIG. 14.

Upon completion of readout of the electric charge from the photodiodes 21-1 to 21-4 in the pixel 411a in the first row, the row selection signal supplied to the control line SEL[2] becomes at the Hi level, and a second row is selected. Furthermore, the pixel reset signal and the electric charge transporting signal respectively supplied to a control line RST[2] and a control line TRAN[5] become at the Hi level, and the transporting transistor 22-1 in the pixel 411a in the second row is in the ON state, and then the electric charge generated in the photodiode 21-1 is transported to the floating diffusion 23-1. Similarly, the electric charges in the photodiodes 21-2 to 21-4 are read, and digital signals are sequentially outputted to the outside of a chip via an output unit which is not shown in FIG. 14.

By repeating the operations described above as many times as the number of rows in the valid part 416, pixel signals are outputted from the pixels 441a in the entire imaging unit 402.

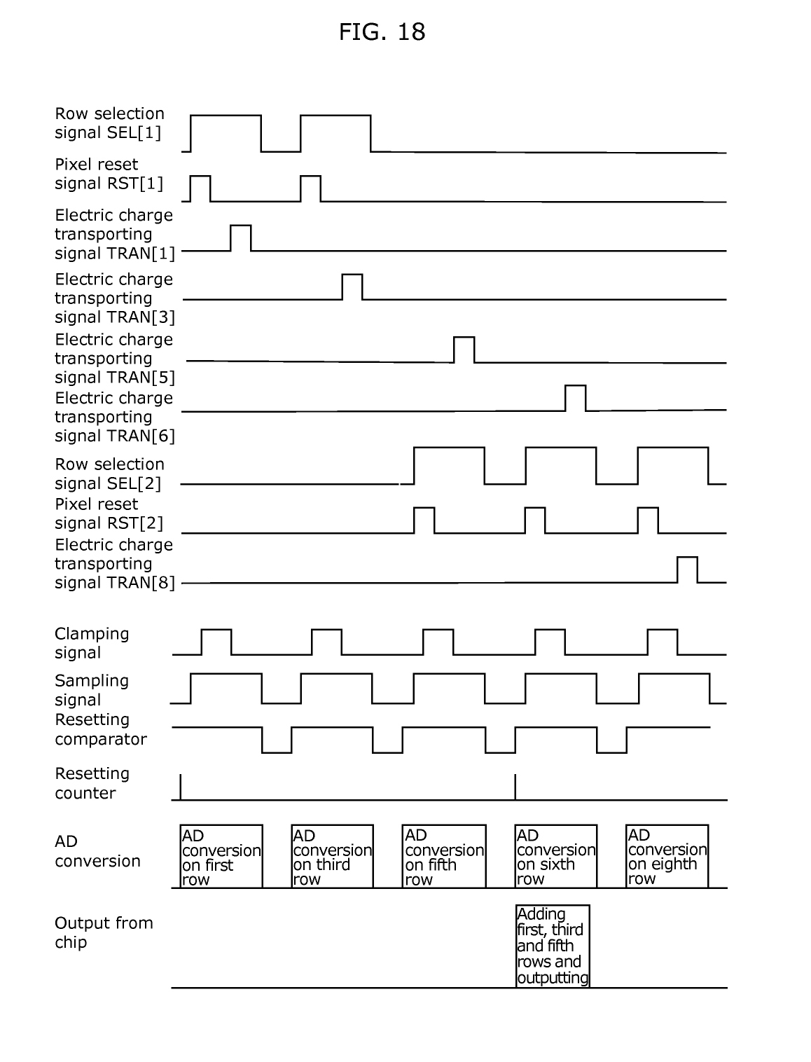

FIG. 18 is a diagram which shows timings of the respective control signals to be supplied to the imaging unit 402 and the column circuit unit 120 in the readout operation from the valid part 416 in the vertical 3/5 row pixel thinning mixture mode in the present embodiment.

In the vertical 3/5 row pixel thinning mixture mode in the present embodiment, the first row is first selected in the imaging unit 402, and pixel signals for a single row in the pixels 411a are read and held in the sample holding circuit 106. Next, the mixed pixel signals are subjected to the AD conversion in the column ADC 144. Then, a third row to be subjected to the mixture is selected, and the AD conversion is performed on the selected third row in the column ADC 144, subsequent to the first row. For the occasion, the counter is counted up subsequent to the count on the first row by performing the reset on the comparator and without performing the reset on the counter. With this, a mixture operation is performed in the ADC. By performing the above operation on the fifth row, pixel signals in three rows among five rows are mixed in the vertical 3/5 row pixel thinning mixture mode.

To be specific, as shown in FIG. 18, the row selection signal to be supplied to the control line SEL[1] becomes at the Hi level, and the first row is selected. The pixel reset signal and the electric charge transporting signal respectively to be supplied to the control line RST[1] and the control line TRAN[1] become at the Hi level, and the transporting transistor 22-1 in the pixel 411a in the first row is in the ON state, and then the electric charge generated in the photodiode 21-1 is transported to the floating diffusion 23-1.

Subsequently, the row selection signal to be supplied to the control line SEL[1] becomes at the Hi level, and the first row is selected. Furthermore, the pixel reset signal and the electric charge transporting signal respectively to be supplied to the control line RST[1] and the control line TRAN[3] become at the Hi level, and the transporting transistor 22-3 in the pixel 411a in the first row is in the ON state, and then the electric charge generated in the photodiode 21-3 is transported to the floating diffusion 23-3.

Furthermore, the row selection signal to be supplied to the control line SEL[2] becomes at the Hi level, and the second row is selected. The pixel reset signal and the electric charge transporting signal respectively to be supplied to the control line RST[2] and the control line TRAN[5] become at the Hi level, and the transporting transistor 22-1 in the pixel 411a in the second row is in the ON state, and then the electric charge generated in the photodiode 21-1 is transported to the floating diffusion 23-1.

Along with the aforementioned transportation of the electric charge generated in the photodiodes 21-1 and 21-3 in the first row and the photodiode 21-1 in the second row, a clamping signal, a sampling signal, and a control signal for resetting the comparator which are shown in FIG. 18 become at the Hi level at the respective timings. Here, contrary to the case in the all-pixel readout mode, the control signal for resetting the counter does not become at the Hi level upon transporting the electric charge from the photodiode 21-3 in the first row and the photodiode 21-1 in the second row, and thus, the counter is not reset. With this, upon transporting the electric charge from the photodiode 21-3 in the first row and the photodiode 21-1 in the second row, the counter is counted up subsequent to the count upon the transportation of the electric charge from the photodiode 21-1 in the first row. Accordingly, electric charges respectively generated by the photodiodes 21-1 and 21-3 in the first row and the photodiode 21-1 in the second row are mixed in the column ADC 144.

Lastly, these mixed pixel signals are subsequently outputted to the outside of a chip via an output unit which is not shown in FIG. 14. By repeating the operations described above as many times as one third number of pixel rows in the valid part 416, pixel signals in the entire imaging unit 402 are outputted.

Meanwhile, the clamping potential in the column circuit unit 120 ranges in the horizontal direction, so that the reference potentials in the respective columns are different for each of the columns. This means that unevenness in the horizontal direction occurs in an output in a dark state, which is the standard of an output image. Accordingly, a horizontal shading occurs in the image.

In contrast, pixel signals in the peripheral part 417 (pixel 411b),0 from which the output in the dark state can be always obtained, are read, and information regarding the pixel signals is used to perform correction at a later stage, to thereby suppress the horizontal shading.

As shown in FIG. 15, the pixels 411a arranged in the valid part 416 have a configuration that the floating diffusions (FD) 23-1 to 23-4 are connected with each other and shared with each other. Since parasitic capacitances of the floating diffusions 23-1 to 23-4 have variations in a unit row cycle (four rows cycle in the present embodiment) for convenience of layout, variations in output offset components in four rows cycle occur at outputting signals in each of rows. This can happen in the pixels 411b arranged in the peripheral part 417. When the valid part 416 and the peripheral part 417 are different from each other in readout orders in a unit row and combinations at the mixture, the output offset components for a unit row cycle cannot be corrected by a clamping correction operation using outputs from the peripheral part 417. This causes insufficient clamping correction operation which leads a factor of deterioration in image quality.

In contrast, in Embodiment 4, the control unit 409 includes an output order adjustment unit 409a. In the first row selection sequence including the row addresses corresponding to the valid part 416 and the second row selection sequence including the row addresses corresponding to the peripheral part 417, the output order adjustment unit 409a generates row address signals so that the order of the rows to be outputted in a unit row and the combination at the mixture are equal to each other between the first row selection sequence and the second row selection sequence, and supplies the generated row address signals. With this, deterioration in an image quality caused by variation in the unit row cycle (four rows cycle in the present embodiment) in the parasitic capacities in the floating diffusions 23-1 to 23-4 can be suppressed.

Next, readout operations on pixel signals in the peripheral part 417 in the aforementioned respective two driving modes included in the solid-state imaging device 401 are described.

In the all-pixel readout mode, as shown in FIG. 8 for Embodiment 1, the pixels 411b from which the pixel signals are read are sequentially selected from the row number 1 in the peripheral part 417 like in the valid part 416. With this, the correction data can be obtained which are in the row numbers same with the physical row numbers of the peripheral part 417.

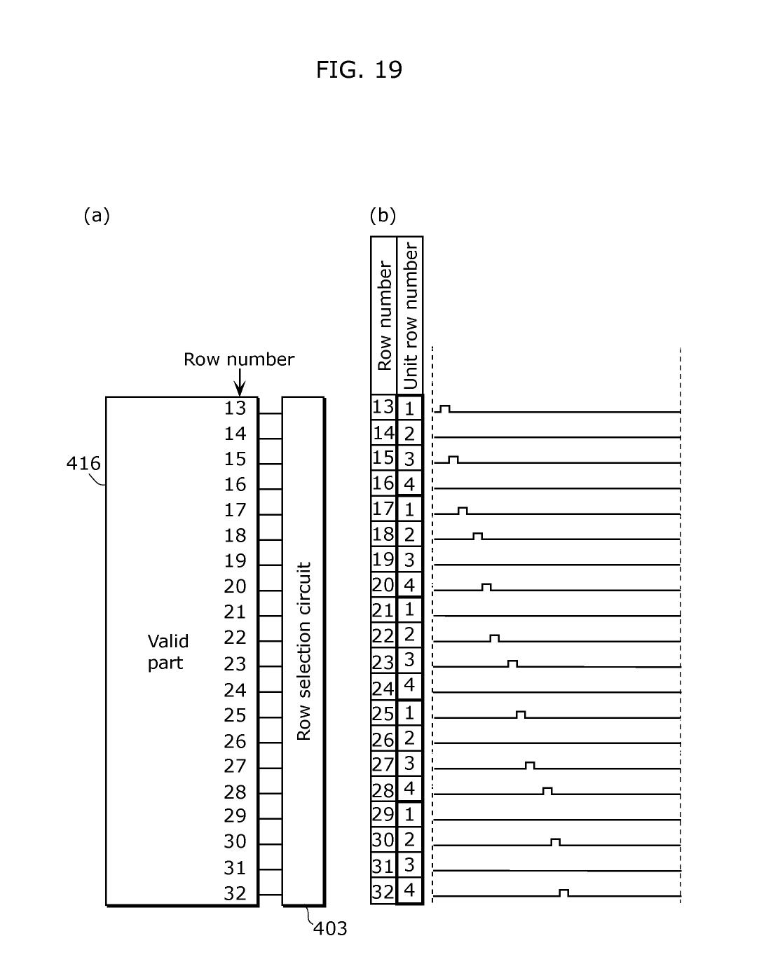

Meanwhile, in the vertical 3/5 row pixel thinning mixture mode, mixture and output are performed by reading three rows among five rows in such a manner that in the valid part 416, the pixel signals in the row numbers 13, 15, and 17 are read and mixed, and then the pixel signals in the row numbers 18, 20, 22 are read and mixed, as shown in FIG. 19. The unit row numbers for the occasion have combinations as (1, 3, 1), (2, 4, 2), (3, 1, 3), (4, 2, 4), and are outputted in this order.

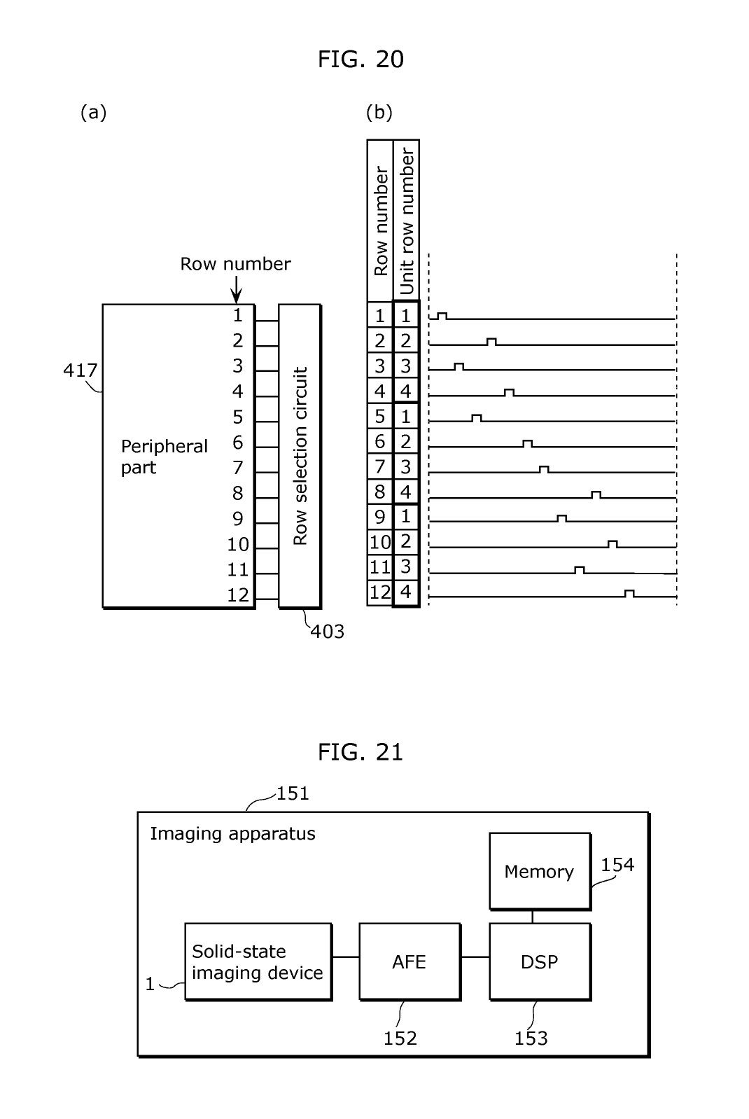

In the peripheral part 417, the row numbers 1, 3, and 5 are read and mixed, and then the row numbers 2, 4, 6 are read and mixed as shown in FIG. 20, which is different from a readout-row selection sequence in the valid part 416. However, the unit row numbers have combinations of (1, 3, 1), (2, 4, 2), (3, 1, 3), (4, 2, 4), and outputted in this order. This is equal to the combination and the output order in the unit row numbers in the valid part 416.

The unit row numbers in FIG. 19 and FIG. 20 indicate the numbers of rows corresponding to the respective photodiodes 21-1 to 21-4 in each of the pixels 411a. The row numbers indicate the numbers of rows corresponding to the respective photodiodes through the entire valid part 416. In addition, a period in which the pixel signals in the unit row having the four combinations of (1, 3, 1), (2, 4, 2), (3, 1, 3), (4, 2, 4) are read is referred to as “a row-readout period per unit row”. This period corresponds to an entire period of the sequences shown in FIG. 19(b) and FIG. 20 (b).

The peripheral part 417 drives to access more rows to secure more rows for outputting per unit row than the valid part 416 does. Specifically, the valid part 416 accesses the row numbers 13, 15, and 17 (unit row numbers 1, 3, 1) and then accesses the row numbers 18, 20, and 22 (unit row numbers 2, 4, 2) which are subsequent to the row number 17, as shown in FIGS. 19 and 20. In contrast, in the peripheral part 417, the row numbers 1, 3, and 5 (unit row numbers 1, 3, 1) are accessed, and then the row numbers 2, 4, and 6 (unit row numbers 2, 4, 2) which are not yet accessed are accessed. In accordance with such a row selection sequence, in the valid part 416, six rows among ten rows are accessed so that two combinations of three rows are secured as output rows, while in the peripheral part 417, six rows in the six rows are accessed so that two combinations of three rows are secured as the output rows.

With this, even in the thinning mixture mode in which the ratio of thinning is high, a ratio of pixel rows (12/20) designated in a row readout period per unit row (for example, a period of reading the row numbers 13 to 32 in FIG. 19) in the first row selection sequence is smaller than a ratio of pixel rows (12/12) designated in a row readout period per unit row (for example, a period of reading the row numbers 1 to 4 in FIG. 20) in the second row selection sequence by applying the first row selection sequence and the second row selection sequence which are outputted from the control unit 409 in this configuration via the output adjustment unit 409a. In other words, more rows for outputting per unit row can be secured in the peripheral part 417 in comparison with the valid part 416, and the combination and the output order of the unit row numbers can be equalized with those of the valid part 416. Accordingly, data for a clamping correction operation, which uses horizontal shading correction data or the data in the peripheral part can be sufficiently obtained. This means that data for the respective corrections can be created with high accuracy. According to the solid-state imaging device described in the present embodiment, a pixel mixture mode, a thinning mode, and thinning mixture mode which have high image quality can be achieved.

Although the pixels 411a having the vertical four pixels one cell configuration as shown in FIG. 15 are described in the present embodiment, a vertical N pixels×horizontal M pixels one cell (N, M=an integer of more than 1) configuration may be used. For example, a vertical two pixels×horizontal two pixels one cell configuration having a unit row number of 2 can be considered. In this case, an FD is placed at the center of the four pixels, to thereby reduce the size of the FD and also reduce a FD capacity. Accordingly, gain upon readout of pixel signals can be increased, which has an advantage in reducing noises on the readout operation.

Although a case is described in which an inter-pixel circuit is shared by a plurality of pixels to configure a single cell, a configuration in which a photodiode configuration has a plurality of pixels different from each other in a single cell may be used. For example, four pixels including photodiodes of different sizes may be in a single cell. The difference in the sizes of photodiodes causes leaked components to be different from each other, so that the output offset differs for each pixel. Accordingly, pixel signals outputted from photodiodes in different sizes are mixed in a later stage, which is effective on enlarging a dynamic range of pixel signals outputted from a single cell. If the pixel thinning mixture mode is achieved, as described above, on a cell including a plurality of pixels, deterioration in accuracy of the correction data due to output offset variation can be suppressed.

### Embodiment 5

Next, Embodiment 5 is described. FIG. 21 is a diagram which shows an overall configuration of an imaging device (camera) according to Embodiment 5.

As shown in FIG. 21, an imaging apparatus 151 according to the present embodiment includes the solid-state imaging device 1 described in Embodiment 1, an analog front-end (AFE) 152, a digital signal processer (DSP) 153, and a memory 154. It should be noted that the solid-state imaging device is not limited to the solid-state imaging device 1 described in Embodiment 1, but may be the solid-state imaging device 101 described in Embodiment 4, or any other solid-state imaging devices described in other embodiments.

The analog front-end 152 performs processing on pixel signals (analog signals) in a valid part 16 and a peripheral part 17, which are outputted from the solid-state imaging device 1, to allow the pixel signals to be digital signals so that the pixel signals can be processed in a digital image signal processing device.

The digital signal processor 153 corrects pixel signals in the valid part 16 which are processed to the digital signals using correction data stored in the memory 154.

The memory 154 stores pixel signals in the peripheral part 17 which are outputted from the solid-state imaging device 1. In other words, the memory 154 stores peripheral data for newly generating correction data, and correction data generated using pixel signals in the peripheral part 17.

The imaging apparatus 151 is driven in an all-pixel readout mode usable for still camera photographing and in a pixel-mixture mode usable for a moving picture recording function.

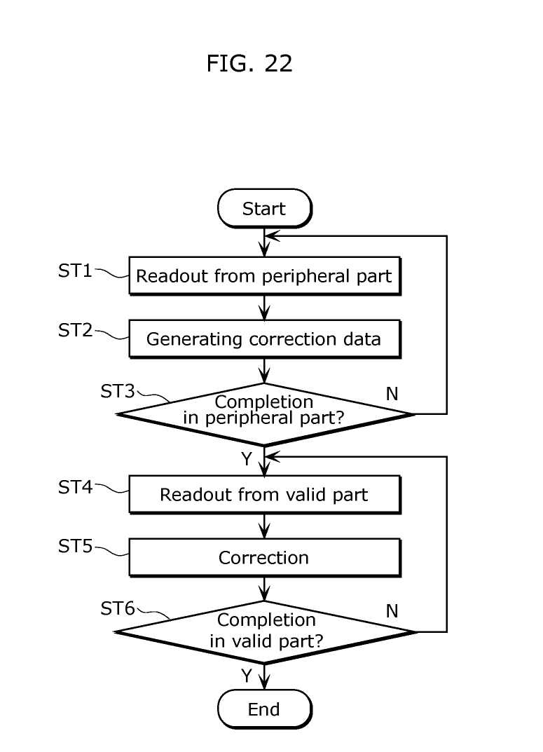

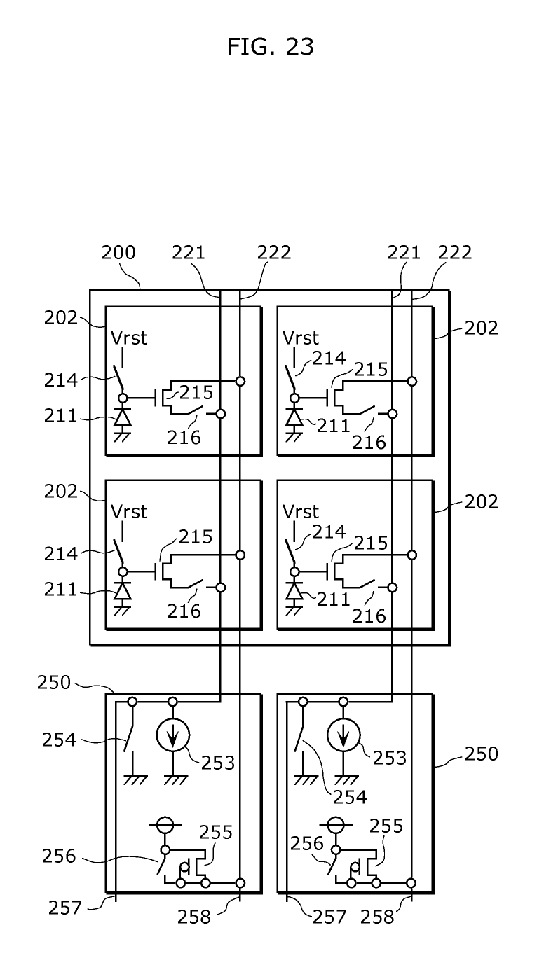

FIG. 22 shows a flowchart for illustrating an operation in the all-pixel readout mode in the imaging device 151.

In a step 1, peripheral part data for a single row is read from pixels 11b arranged in the peripheral part 17 shown in FIG. 1 (ST1). At this time, for the imaging unit 2 in the solid-state imaging device 1, only a single row is selected and readout operation is performed.

In a step 2, new correction data is generated using a value of the peripheral part data detected in the step 1 and a value of the correction data stored in the memory 154 (ST2).

In a step 3, it is determined whether or not the readout on the peripheral part 17 is completed, and if the result is NO, processing returns to the step 1 (ST3). As described above, if the step 1 and the step 2 are performed on an entire of the peripheral part 17, the correction data composed of averages of outputs from respective columns in the peripheral part 17 can be obtained. This correction data corresponds to horizontal shading data in a dark state. This correction data is held in the memory 154.

Subsequently, pixels for a single row in the valid part 16 are read in a step 4 (ST4). At this time, for the imaging unit 2 in the solid-state imaging device 1, only a single row is selected and read out.

In a step 5, the horizontal shading is corrected by subtracting the correction data held in the memory 154 from the data obtained in the step 4 (ST5).

In a step 6, it is determined whether or not the readout on the peripheral part 16 is completed, and if the result is NO, the processing returns to the step 4 (ST6).

As described above, processing in the steps 4 and 5 is performed on the entire of the valid part 16, to thereby obtain an image with high image quality, in which the horizontal shading is corrected for the entire of the valid part 16.

Next, an operation in the pixel-mixture mode is described. A flowchart for describing an operation in the pixel-mixture mode is the same with that in the all-pixel readout mode as shown in FIG. 22.

In a step 1, peripheral part data is read for one-by-one row from pixels 11b arranged in the peripheral part 17 shown in FIG. 1. At this time, for the imaging unit 2 in the solid-state imaging device 1, only a single row is selected and read (ST1).

In a step 2, new correction data is created using a value of the peripheral part data detected in the step 1 and a value of the correction data stored in the memory 154 (ST2).

In a step 3, it is determined whether or not the readout on the peripheral part 17 is completed, and if the result is NO, the processing returns to the step 1 (ST3). As described above, if the processing in the step 1 and the processing in the step 2 are performed on an entire of the peripheral part 17, the correction data composed of averages of outputs from respective columns in the peripheral part 17 can be obtained. This correction data correspond to horizontal shading data in a dark state. This correction data is held in the memory 154.

Subsequently, pixels for two rows in the valid part 16 are read in a step 4 (ST4). At this time, for the imaging unit 2 in the solid-state imaging device 1, two rows are selected and read out at the same time. A pixel mixture signal is outputted from the solid-state imaging device 1 by an operation of mixing a vertical signal and a horizontal signal upon the readout of signals.

In a step 5, the horizontal shading is corrected by subtracting the correction data held in the memory 154 from the data obtained in the step 4 (ST5).

In a step 6, it is determined whether or not the readout on the valid part 16 is completed, and if the result is NO, the processing returns to the step 4 (ST6).

As described above, the processing in the steps 4 and 5 is performed on the entire of the valid part 16, to thereby obtain a mixture image having mixed signals from a plurality of pixels in the valid part 16 with high image quality. In the mixture image, the horizontal shading is corrected for the entire of the valid part 16. The correction data for the occasion is generated from multiple peripheral-part data items equal to those in the all-pixel readout mode, to thereby achieve the correction with high accuracy.

It should be noted that the present invention is not limited to the above embodiment, and various modification or variation without departing from the spirit of the present invention may be added.

For example, pixels arranged in the valid part and the peripheral part are not limited to the aforementioned number and arrangement. The number and the arrangement may be appropriately changed.

The pixels in the peripheral part are not limited to light-shielding pixels prepared by preliminarily shielding pixels from light, but may be pixels which output a reference voltage at a constant intensity.

The readout of pixel signals from the valid part and the peripheral part in the pixel-mixture mode is not limited to be performed with the readout method described in the above embodiment, but may be performed with other methods. For example, the readout is not limited to be performed in the vertical two pixels horizontal two pixels mixture readout mode in which pixel signals in two pixels in the column direction and pixel signals in two pixels in the row direction are mixed, but may be performed in other mixture modes. Furthermore, a combination of rows from which pixel signals are mixed to be read is not limited to those in the aforementioned embodiments, but may be any combinations.

In the pixel thinning mixture mode, the number of pixel signals to be mixed and the number of the pixel signals to be thinned are not limited to those in the vertical 3/5 row pixel thinning mixture mode, but the number of mixed pixels and the number of the thinned pixels may be changed.

It should be noted that the correction in the horizontal shading and the clamping correction may be performed under a condition that a digital signal processor circuit is installed in a solid-state imaging device.

Furthermore, the driving mode is not limited to the pixel thinning mixture mode, but may be changed to the pixel-mixture mode or the thinning mode.

Although in the pixel thinning mixture mode, pixels in a configuration that vertical four pixels make up one cell are described, pixels may be in the configuration that vertical N pixels×horizontal M pixels (N, M=an integer of 1 or more) configure one cell. For example, one cell including vertical two pixels and horizontal two pixels can be considered. In this case, an FD is placed at the center of the four pixels, to thereby reduce a size of the FD and reduce an FD capacity. Accordingly, gain upon readout of the pixel signal can be increased, which has an advantage in reducing noises on the readout operation.

Although a case is described in which an inter-pixel circuit is shared by a plurality of pixels to configure a single cell, a configuration in which a photodiode is configured to have a plurality of pixels different from each other in a single cell may be used. For example, four pixels including photodiodes of different sizes may be in a single cell. The difference in the sizes of photodiodes causes leaked components to be different from each other, so that the output offset differs for each pixel. Accordingly, pixel signals outputted from photodiodes in different sizes are mixed in a later stage, which is effective on enlarging a dynamic range of pixel signals outputted from a single cell. If the pixel thinning mixture mode is achieved, as described above, on a cell including a plurality of pixels, deterioration in accuracy of the correction data due to output offset variation can be suppressed.

Furthermore, the solid-state imaging device and the imaging apparatus according to the present invention are not limited to the aforementioned embodiments, but may be in any configurations. For example, the configurations of a pixel current source circuit, a clamping circuit, a sample holding circuit, a multiplexer, a column selection circuit, a column ADC, and a digital mixture unit may be changed, or combination of these units may be changed.

The solid-state imaging device according to the present invention involves other embodiments achieved by combining any structural components in the aforementioned embodiment, modifications obtained by adding various modification conceivable by a person skilled in the art in the scope of the present invention as long as the modifications do not depart from the scope of the invention, and various devices including the solid-state imaging device according to the present invention.

### INDUSTRIAL APPLICABILITY

A solid-state imaging device according to one or more exemplary embodiments disclosed herein is usable as an imaging sensor for an imaging apparatus, such as a digital single-lens reflex camera or a fancy compact camera, for which high image quality and high functionality are required.

1. A solid-state imaging device driven in a plurality of driving modes, comprising:
an imaging unit including a plurality of pixels arranged two-dimensionally;
a row selection circuit which selects a pixel row including pixels among the pixels arranged in a row direction;
a column circuit unit configured to temporarily hold pixel signals outputted from the selected pixel row; and
a control unit configured to supply a row address signal which designates a pixel row to be selected to the row selection circuit,
wherein the pixels include:
a plurality of first pixels which output pixel signals dependent on quantity of received light; and
a plurality of second pixels which output pixel signals at a constant intensity regardless of the quantity of the received light,
the imaging unit includes:
a valid part including the first pixels; and
a peripheral part including the second pixels which are arranged on a periphery of the valid part, and
the control unit is configured to generate and supply, to the row selection circuit, a first row selection sequence including the row address signal which designates the pixel row belonging to the valid part and a second row selection sequence including the row address signal which designates the pixel row belonging to the peripheral part so that the number of pixel rows simultaneously designated in the first row selection sequence and the second row selection sequence or the number of times that each of the pixel rows is designated varies, in at least one of the driving modes.

2. The solid-state imaging device according to claim 1,
wherein the control unit is configured to generate the first row selection sequence and the second row selection sequence so that the number of pixel rows designated in a single row-readout period in the first row selection sequence is larger than the number of pixel rows designated in the single row-readout period in the second row selection sequence.

3. The solid-state imaging device according to claim 1,
wherein the control unit is configured to generate, in a single frame period, the first row selection sequence and the second row selection sequence so that the number of times that each of the pixel rows is designated by the first row selection sequence is less than the number of times that each of the pixel rows is designated by the second row selection sequence.

4. The solid-state imaging device according to claim 1,
wherein the control unit is configured to designate (i) two or more of the pixel rows in a single row-readout period in the first row selection sequence, and (ii) one of the pixel rows in the single row-readout period in the second row selection sequence.

5. The solid-state imaging device according to claim 1,
wherein the control unit is configured to designate (i) two or more of the pixel rows in a single row-readout period in the first row selection sequence, and (ii) two or more of the pixel rows the number of which is different from the number of the pixel rows designated in the first row selection sequence, in the single row-readout period in the second row selection sequence.

6. The solid-state imaging device according to claim 3,
wherein the control unit is configured to:
(i) designate, in the first row selection sequence, two or more of the pixel rows in a single row-readout period, and
(ii) designate, in the second row selection sequence, an Nth pixel row (N is an integer of 1 or more) along with an Mth pixel row (M is an integer of 1 or more, and M≠N) in the single row-readout period, and designate the Nth pixel row more than once with a value of M being changed in the single frame period.

7. The solid-state imaging device according to claim 6,
wherein the designating more than once indicates designating twice.

8. A solid-state imaging device driven in a plurality of driving modes, comprising:
an imaging unit including a plurality of pixels arranged two-dimensionally;
a row selection circuit which selects a pixel row including pixels among the pixels arranged in a row direction;
a column circuit unit configured to temporarily hold pixel signals outputted from the selected pixel row; and
a control unit configured to supply a row address signal which designates a pixel row to be selected to the row selection circuit,
wherein the pixels include:
a plurality of first pixels which output pixel signals dependent on quantity of received light; and
a plurality of second pixels which output pixel signals at a constant intensity regardless of the quantity of the received light,
the imaging unit includes:
a valid part including the first pixels; and
a peripheral part including the second pixels which are arranged on a periphery of the valid part,
in at least one of the driving modes,
the control unit includes an output order adjustment unit configured to adjust an output order of row address signals including the row address signal,
the output order adjustment unit is configured to adjust the output order of the row address signals so that orders and combinations of the numbers of rows to be outputted per unit row are equal to each other in a first row selection sequence and in a second row selection sequence, and generate the first row selection sequence including the row address signal which designates the pixel row belonging to the valid part and the second selection sequence including the row address signal which designates the pixel row belonging to the peripheral part, and
the control unit is configured to supply, to the row selection circuit, the first row selection sequence and the second row selection sequence which have been adjusted in terms of the output order of the row address signals.

9. The solid-state imaging device according to claim 8,
wherein the output order adjustment unit is configured to generate the first row selection sequence and the second row selection sequence so that a ratio of (i) to (ii) in the first row selection sequence is smaller than a ratio of the (i) to the (ii) in the second row selection sequence, the (i) indicating the pixel row designated in a row-readout period per unit row, and the (ii) indicating the number of pixel rows per unit row.

10. The solid-state imaging device according to claim 8,
wherein the unit row includes four pixel rows.

11. The solid-state imaging device according to claim 8,
wherein the unit row includes two pixel rows.

12. The solid-state imaging device according to claim 1,
wherein each of the second pixels includes a light-shielding pixel in which a pixel is shielded from light or a reference voltage output pixel which outputs a reference voltage.

13. The solid-state imaging device according to claim 1,
wherein the peripheral part is placed closer to a periphery of the imaging unit than the valid part is.

14. An imaging device comprising:
the solid-state imaging device according to claim 1;
a digital signal processing unit configured to perform correction processing on a pixel signal in the valid part, which is outputted from the solid-state imaging device; and
a storage unit configured to store a pixel signal in the peripheral part, which is outputted from the solid-state imaging device, and correction data generated using the pixel signal in the peripheral part.
